(19) United States
(12) Patent Application Publication
(10) Pub. No.: US 2015/0170656 A1
(43) Pub. Date: Jun. 18, 2015

(54) AUDIO ENCODING DEVICE, AUDIO CODING METHOD, AND AUDIO DECODING DEVICE

(71) Applicant: FUJITSU LIMITED, Kawasaki-shi (JP)

(72) Inventors: Yohei KISHI, Kawasaki (JP); Akira Kamano, Kawasaki (JP); Takeshi Otani, Kawasaki (JP)

(21) Appl. No.: 14/496,272

(22) Filed: Sep. 25, 2014

(30) Foreign Application Priority Data
Dec. 16, 2013 (JP) 2013-259524

(51) Int. Cl. G10L 19/008

(52) U.S. Cl. CPC G10L 19/008

(57) ABSTRACT

An audio encoding device includes a processor; and a memory which stores a plurality of instructions, which when executed by the processor, cause the processor to execute: mixing a channel signal of a first number included in a plurality of channels contained in an audio signal as a downmix signal of a second number; calculating a residual signal representing an error between the downmix signal and the channel signal of the first number; determining a window length of the downmix signal; and performing orthogonal transformation of the downmix signal and the residual signal based on the window length.

### CROSS-REFERENCE TO RELATED APPLICATION

This application is based upon and claims the benefit of priority from the prior Japanese Patent Application No. 2013-259524 filed on Dec. 16, 2013, the entire contents of which are incorporated herein by reference.

### FIELD

The embodiments discussed herein are related to, for example, audio encoding devices, audio coding methods, audio coding programs, and audio decoding devices.

### BACKGROUND

Audio signal coding methods of compressing the data amount of a multi-channel audio signal having three or more channels have been developed. As one of such coding methods, the MPEG Surround method standardized by Moving Picture Experts Group (MPEG) is known. In the MPEG Surround method, for example, an audio signal of 5.1 channels (5.1 ch) to be encoded is subjected to time-frequency transformation, and a frequency signal thus obtained is downmixed to once generate a three-channel frequency signal. Further, the three-channel frequency signal is downmixed again to calculate a frequency signal corresponding to a two-channel stereo signal. Then, the frequency signal corresponding to the stereo signal is encoded by the Advanced Audio Coding (MC) coding method, and if desirable, by the Spectral band replication (SBR) coding method. On the other hand, in the MPEG Surround method, when a signal of 5.1 channels is downmixed to produce a signal of three channels, or when a signal of three channels is downmixed to produce a signal of two channels, spatial information representing sound spread and localization and a residual signal is calculated and then encoded. In such a manner, the MPEG Surround method encodes a stereo signal generated by downmixing a multi-channel audio signal and spatial information having less data amount. Thus, the MPEG Surround method provides compression efficiency higher than the efficiency obtained by independently coding signals of channels contained in the multi-channel audio signal. A technique relating to coding of the multi-channel audio signal is disclosed, for example, in Japanese Laid-open Patent Application No. 2012-141412.

The residual signal described above is a signal representing an error component in the downmixing. Since an error in the downmixing may be corrected by using the residual signal during decoding, an audio signal yet subjected to the downmixing may be reproduced accurately.

### SUMMARY

In accordance with an aspect of the embodiments, an audio encoding device includes a processor; and a memory which stores a plurality of instructions, which when executed by the processor, cause the processor to execute: mixing a channel signal of a first number included in a plurality of channels contained in an audio signal as a downmix signal of a second number; calculating a residual signal representing an error between the downmix signal and the channel signal of the first number; determining a window length of the downmix signal; and performing orthogonal transformation of the downmix signal and the residual signal based on the window length.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a functional block diagram of an audio encoding device according to one embodiment.

FIG. 2 is a diagram illustrating an example of a quantization table (codebook) relative to a predictive coefficient.

FIG. 3 is a diagram illustrating an example of a quantization table relative to a similarity.

FIG. 4 is an example of a table illustrating a relationship between an index differential value and a similarity code.

FIG. 5 is a diagram illustrating an example of a quantization table relative to an intensity difference.

FIG. 6 is a diagram illustrating an example of a data format in which an encoded audio signal is stored.

FIG. 7A is a diagram illustrating a window length determination result of a time signal of a left frequency signal L₀(k,n) and a right frequency signal R₀(k,n).

FIG. 7B is a diagram illustrating a window length determination result of a time signal of a left-channel residual signal res_{L}(k,n) and a right-channel residual signal res_{R}(k,n).

FIG. 8 is a functional block diagram of an audio encoding device according to one embodiment (comparative example).

FIG. 9A is a conceptual diagram of a delay amount of a multi-channel audio signal according to Embodiment 1.

FIG. 9B is a conceptual diagram of a delay amount of a multi-channel audio signal according to Comparative Example 1.

FIG. 10A is a spectrum diagram of a decoded multi-channel audio signal to which a coding according to Embodiment 1 is applied.

FIG. 10B is a spectrum diagram of a decoded multi-channel audio signal to which a coding according to Comparative Example 1 is applied.

FIG. 11 is an operation flowchart of audio coding processing.

FIG. 12 is a functional block diagram of an audio decoding device according to one embodiment.

FIG. 13 is a functional block diagram (Part 1) of an audio encoding/decoding system according to one embodiment.

FIG. 14 is a functional block diagram (Part 2) of an audio encoding/decoding system according to one embodiment.

FIG. 15 is a hardware configuration diagram of a computer functioning as an audio encoding device or an audio decoding device according to one embodiment.

### DESCRIPTION OF EMBODIMENTS

Hereinafter, examples of an audio encoding device, an audio coding method and an audio coding computer program as well as an audio decoding device according to an embodiment are described in detail based on the accompanying drawings. The examples do not limit the disclosed technology.

### Embodiment 1

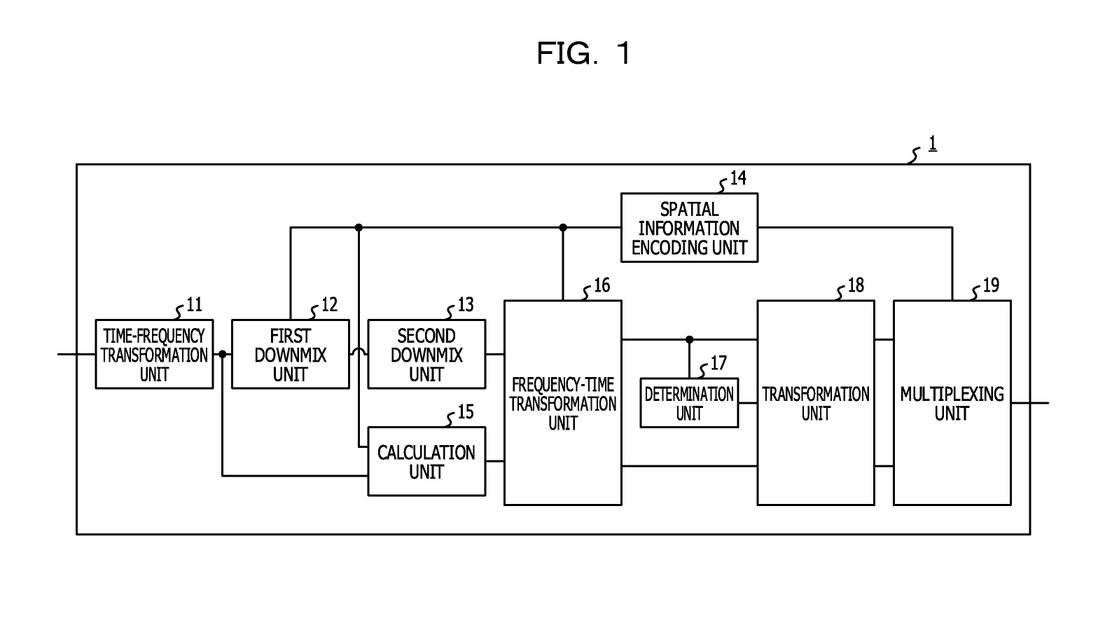

FIG. 1 is a functional block diagram of an audio encoding device 1 according to one embodiment. As illustrated in FIG. 1, the audio encoding device 1 includes a time-frequency transformation unit 11, a first downmix unit 12, a second downmix unit 13, a spatial information encoding unit 14, a calculation unit 15, a frequency-time transformation unit 16, a determination unit 17, a transformation unit 18, and a multiplexing unit 19.

These components included in the audio encoding device 1 are formed as separate hardware circuits using wired logic, for example. Alternatively, these components included in the audio encoding device 1 may be implemented in the audio encoding device 1 as a single integrated circuit in which circuits corresponding to the respective components are integrated. The integrated circuit may be an integrated circuit such as, for example, application specific integrated circuit (ASIC) and field programmable gate array (FPGA). Further, these components included in the audio encoding device 1 may be function modules which are achieved by a computer program executed on a processor included in the audio encoding device 1.

The time-frequency transformation unit 11 is configured to transform signals of the respective channels (for example, signals of 5.1 channels) in the time domain of a multi-channel audio signal entered into the audio encoding device 1 to frequency signals of the respective channels by time-frequency transformation on the frame by frame basis. In Embodiment 1, the time-frequency transformation unit 11 transforms signals of the respective channels to frequency signals by using a Quadrature Mirror Filter (QMF) of the following equation.

$$QMF ( k , n ) = exp [ j \frac{π}{128} ( k + 0.5 ) ( 2 n + 1 ) ] , \\ 0 \leq k < 64 , \\ 0 \leq n < 128 \qquad ( Equation 1 )$$

Here, “n” is a variable representing an nth time when the audio signal in one frame is divided into 128 parts in the time direction. The frame length may be, for example, any value of 10 to 80 msec. “k” is a variable representing a kth frequency band when a frequency band of a frequency signal is divided into 64 parts. QMF(k,n) is QMF for outputting a frequency signal having the time “n” and the frequency “k”. The time-frequency transformation unit 11 generates a frequency signal of an entered channel by multiplying QMF (k,n) by an audio signal for one frame of the channel. The time-frequency transformation unit 11 may transform signals of the respective channels to frequency signals through separate time-frequency transformation processing such as fast Fourier transform, discrete cosine transform, and modified discrete cosine transform.

Every time calculating a frequency signal of a channel on the frame by frame basis, the time-frequency transformation unit 11 outputs the frequency signal (for example, left front channel frequency signal L(k,n), left rear channel frequency signal SL(k,n), right front channel frequency signal R(k,n), right rear channel frequency signal SR(k,n), center-channel frequency signal C(k,n), and deep bass sound channel frequency signal LFE(k,n)) to the first downmix unit 12 and the calculation unit 15.

The first downmix unit 12 is configured to generate left-channel, center-channel and right-channel frequency signals by downmixing frequency signals of the respective channels every time receiving these signals from the time-frequency transformation unit 11. In other words, the first downmix unit 12 mixes a signal of a first number included in multiple channels contained in the audio signal as a downmix signal of a second number. Specifically, the first downmix unit 12 calculates, for example, frequency signals of the following three channels in accordance with the following equation.

Lᵢₙ(k,n)=L_{in Re}(k,n)+j·L_{in Im}(k,n) 0≦k<64, 0≦n<128

L_{in Re}(k,n)=L_{Re}(k,n)+SL_{Re}(k,n)

L_{in Im}(k,n)=L_{Im}(k,n)+SL_{Im}(k,n)

Rᵢₙ(k,n)=R_{in Re}(k,n)+j·R_{in Im}(k,n) 0≦k<64, 0≦n<128

R_{in Re}(k,n)=R_{Re}(k,n)+SR_{Re}(k,n)

R_{in Im}(k,n)=R_{Im}(k,n)+Sr_{Im}(k,n)

Cᵢₙ(k,n)=C_{in Re}(k,n)+j·C_{in Im}(k,n) 0≦k<64, 0≦n<128

C_{in Re}(k,n)=C_{Re}(k,n)+LFE_{Re}(k,n)

C_{in Im}(k,n)=C_{Im}(k,n)+LFE_{Im}(k,n) (Equation 2)

In Equation 2, L_{Re}(k,n) represents a real part of the left front channel frequency signal L(k,n), and L_{Im}(k,n) represents an imaginary part of the left front channel frequency signal L(k,n). SL_{Re}(k,n) represents a real part of the left rear channel frequency signal SL(k,n), and SL_{Im}(k,n) represents an imaginary part of the left rear channel frequency signal SL(k,n). Lᵢₙ(k,n) is a left-channel frequency signal generated by downmixing. L_{inRe}(k,n) represents a real part of the left-channel frequency signal, and L_{inIm}(k,n) represents an imaginary part of the left-channel frequency signal.

Similarly, R_{Re}(k,n) represents a real part of the right front channel frequency signal R(k,n), and R_{Im}(k,n) represents an imaginary part of the right front channel frequency signal R(k,n). S R_{Re}(k,n) represents a real part of the right rear channel frequency signal SR(k,n), and SR_{Im}(k,n) represents an imaginary part of the right rear channel frequency signal SR(k,n). Rᵢₙ(k,n) is a right-channel frequency signal generated by downmixing. R_{inRe}(k,n) represents a real part of the right-channel frequency signal, and R_{inIm}(k,n) represents an imaginary part of the right-channel frequency signal.

Further, C_{Re}(k,n) represents a real part of the center-channel frequency signal C(k,n), and C_{Im}(k,n) represents an imaginary part of the center-channel frequency signal C(k,n). LFE_{Re}(k,n) represents a real part of the deep bass sound channel frequency signal LFE(k,n), and LFE_{Im}(k,n) represents an imaginary part of the deep bass sound channel frequency signal LFE(k,n). Cᵢₙ(k,n) represents a center-channel frequency signal generated by downmixing. Further, C_{inRe}(k,n) represents a real part of the center-channel frequency signal Cᵢₙ(k,n), and C_{inIm}(k,n) represents an imaginary part of the center-channel frequency signal Cᵢₙ(k,n).

The first downmix unit 12 calculates, on the frequency band basis, an intensity difference between frequency signals of two channels to be downmixed, and a similarity between the frequency signals, as spatial information between the frequency signals. The intensity difference is information representing the sound localization, and the similarity turns information representing the sound spread. The spatial information calculated by the first downmix unit 12 is an example of three-channel spatial information. In Embodiment 1, the first downmix unit 12 calculates, for example, an intensity difference CLD_{L}(k) and a similarity ICC_{L}(k) in a frequency band k of the left channel in accordance with the equations given below.

$$\begin{matrix}{CLD}_{L} ( k ) = 10 {log}_{10} ( \frac{{e}_{L} ( k )}{{e}_{SL} ( k )} ) & ( Equation 3 ) \\ {ICC}_{L} ( k ) = Re \{ \frac{{e}_{LSL} ( k )}{\sqrt{{e}_{L} ( k ) \cdot {e}_{SL} ( k )}} \} \\ {e}_{L} ( k ) = {\sum }_{n = 0}^{N - 1} {\vert L ( k , n ) \vert}^{2} \\ {e}_{SL} ( k ) = {\sum }_{n = 0}^{N - 1} {\vert SL ( k , n ) \vert}^{2} \\ {e}_{LSL} ( k ) = {\sum }_{n = 0}^{N - 1} L ( k , n ) \cdot SL ( k , n ) & ( Equation 4 )\end{matrix}$$

where “N” represents the number of clockwise samples contained in one frame. In Embodiment 1, “N” is 128. e_{L}(k) represents an autocorrelation value of left front channel frequency signal L(k,n), and e_{SL}(k) is an autocorrelation value of left rear channel frequency signal SL(k,n). e_{LSL}(k) represents a cross-correlation value between the left front channel frequency signal L(k,n) and the left rear channel frequency signal SL(k,n).

Similarly, the first downmix unit 12 calculates an intensity difference CLD_{R}(k) and a similarity ICC_{R}(k) in a frequency band k of the right channel in accordance with the equations given below.

$$\begin{matrix}{CLD}_{R} ( k ) = 10 {log}_{10} ( \frac{{e}_{R} ( k )}{{e}_{SR} ( k )} ) & ( Equation 5 ) \\ {ICC}_{R} ( k ) = Re \{ \frac{{e}_{RSR} ( k )}{\sqrt{{e}_{R} ( k ) \cdot {e}_{SR} ( k )}} \} \\ {e}_{R} ( k ) = {\sum }_{n = 0}^{N - 1} {\vert R ( k , n ) \vert}^{2} \\ {e}_{SR} ( k ) = {\sum }_{n = 0}^{N - 1} {\vert SR ( k , n ) \vert}^{2} \\ {e}_{RSR} ( k ) = {\sum }_{n = 0}^{N - 1} L ( k , n ) \cdot SR ( k , n ) & ( Equation 6 )\end{matrix}$$

where e_{R}(k) represents an autocorrelation value of the right front channel frequency signal R(k,n), and e_{SR}(k) is an autocorrelation value of the right rear channel frequency signal SR(k,n). e_{RSR}(k) represents a cross-correlation value between the right front channel frequency signal R(k,n) and the right rear channel frequency signal SR(k,n).

Further, the first downmix unit 12 calculates an intensity difference CLD_{C}(K) in a frequency band k of the center channel in accordance with the following equation.

$${CLD}_{C} ( k ) = 10 {log}_{10} ( \frac{{e}_{C} ( k )}{{e}_{LFE} ( k )} ) \\ {}_{}^{e}{C}{}_{}^{( k )} = {\sum }_{n = 0}^{N - 1} {\vert C ( k , n ) \vert}^{2} \\ {}_{}^{e}{LFE}{}_{}^{( k )} = {\sum }_{n = 0}^{N - 1} {\vert LFE ( k , n ) \vert}^{2} \qquad ( Equation 7 )$$

where e_{C}(k) represents an autocorrelation value of the center-channel frequency signal C(k,n), and e_{LFE}(k) is an autocorrelation value of the deep bass sound channel frequency signal LFE(k,n). Intensity differences CLD_{L}(k), CLD_{R}(k) and CLD_{C}(k), and similarities ICC_{L}(k) and ICC_{R}(k) calculated by the first downmix unit 12 may be collectively referred to as first spatial information SAC(k) for the sake of convenience.

The first downmix unit 12 outputs the left-channel frequency signal Lᵢₙ(k,n), the right-channel frequency signal Rᵢₙ(k,n), and the center-channel frequency signal Cᵢₙ(k,n), which are generated by downmixing, to the second downmix unit 13, and outputs the first spatial information SAC(k) to the spatial information encoding unit 14 and the calculation unit 15.

The second downmix unit 13 receives three-channel frequency signals including the left-channel frequency signal Lᵢₙ(k,n), the right-channel frequency signal Rᵢₙ(k,n), and the center-channel frequency signal Cᵢₙ(k,n), respectively generated by the first downmix unit 12. The second downmix unit 13 generates a left frequency signal in the stereo frequency signal by downmixing the left-channel frequency signal and the center-channel frequency signal out of the three-channel frequency signal. Further, the second downmix unit 13 generates a right frequency signal in the stereo frequency signal by downmixing the right-channel frequency signal and the center-channel frequency signal. The second downmix unit 13 generates, for example, a left frequency signal L₀(k,n) and a right frequency signal R₀(k,n) in the stereo frequency signal in accordance with the following equation. Further, the first downmix unit 12 calculates, for example, a center-channel signal C₀(k,n) utilized for selecting a predictive coefficient contained in the codebook according to the following equation.

$$( \begin{matrix}{L}_{0} ( k , n ) \\ {R}_{0} ( k , n ) \\ {C}_{0} ( k , n )\end{matrix} ) = ( \begin{matrix}1 & 0 & \frac{\sqrt{2}}{2} \\ 0 & 1 & \frac{\sqrt{2}}{2} \\ 1 & 1 & - \frac{\sqrt{2}}{2}\end{matrix} ) ( \begin{matrix}{L}_{in} ( k , n ) \\ {R}_{in} ( k , n ) \\ {C}_{in} ( k , n )\end{matrix} ) \qquad ( Equation 8 )$$

In Equation 8, Lᵢₙ(k,n), Rᵢₙ(k,n), and Cᵢₙ(k,n) are respectively left-channel, right-channel, and center-channel frequency signals generated by the first downmix unit 12. The left frequency signal L₀(k,n) is a synthesis of left front channel, left rear channel, center-channel and deep bass sound frequency signals of an original multi-channel audio signal. Similarly, the right frequency signal R₀(k,n) is a synthesis of right front channel, right rear channel, center-channel and deep bass sound frequency signals of the original multi-channel audio signal. The left frequency signal L₀(k,n) and the right frequency signal R₀(k,n) in Equation 8 may be expanded as follows:

$${L}_{0} ( k , n ) = ( {L}_{in Re} ( k , n ) + \frac{\sqrt{2}}{2} {C}_{in Re} ( k , n ) ) + ( {L}_{in Im} ( k , n ) + \frac{\sqrt{2}}{2} {C}_{in Im} ( k , n ) ) \\ {R}_{0} ( k , n ) = ( {R}_{in Re} ( k , n ) + \frac{\sqrt{2}}{2} {C}_{in Re} ( k , n ) ) + ( {R}_{in Im} ( k , n ) + \frac{\sqrt{2}}{2} {C}_{in Im} ( k , n ) ) \qquad ( Equation 9 )$$

The second downmix unit 13 selects a predictive coefficient from the codebook for frequency signals of two channels to be downmixed by the second downmix unit 13, as appropriate. For example, when performing predictive coding of the center-channel signal C₀(k,n) from the left frequency signal L₀(k,n) and the right frequency signal R₀(k,n), the second downmix unit 13 generates a two-channel stereo frequency signal by downmixing the right frequency signal R₀(k,n) and the left frequency signal L₀(k,n). When performing predictive coding, the second downmix unit 13 selects, from the codebook, predictive coefficients C₁(k) and C₂(k) such that an error d(kn) between a frequency signal before predictive coding and a frequency signal after predictive coding becomes minimum, the error being defined on the frequency band basis in the following equations with C₀(k,n), L₀(k,n), and R₀(k,n). In such a manner, the second downmix unit 13 may perform predictive coding of the center-channel signal C′₀(k,n) subjected to predictive coding.

$$d ( k , n ) = {\sum }_{k}^{ } {\sum }_{n}^{ } \{ {\vert {C}_{0} ( k , n ) - {C}_{0}^{′} ( k , n ) \vert}^{2} \} \\ {C}_{0}^{′} ( k , n ) = {c}_{1} ( k ) \cdot {L}_{0} ( k , n ) + {c}_{2} ( k ) \cdot {R}_{0} ( k , n ) \qquad ( Equation 10 )$$

Equation 10 may be expressed as follows by using real and imaginary parts.

C′₀(k,n)=C′_{0Re}(k,n)+C′_{0Im}(k,n)

C′_{0Re}(k,n)=c₁×L_{0Re}(k,n)+c₂×R_{0Re}(k,n)

C′_{0Im}(k,n)=c₁×L_{0Im}(k,n)+c₂×R_{0Im}(k,n) (Equation 11)

L_{0Re}(k,n), L_{0Im}(k,n), R_{0Re}(k,n), and R_{0Im}(k,n) represent a real part of L₀(k,n), an imaginary part of L₀(k,n), a real part of R₀(k,n), and an imaginary part of R₀(k,n), respectively.

As described above, the second downmix unit 13 may perform predictive coding of the center-channel signal C₀(k,n) by selecting, from the codebook, predictive coefficients C₁(k) and C₂(k) such that the error d(kn) between a center-channel frequency signal C₀(k,n) before predictive coding and a center-channel frequency signal C′₀(k,n) after predictive coding becomes minimum. Equation 10 represents this concept in the form of the equation.

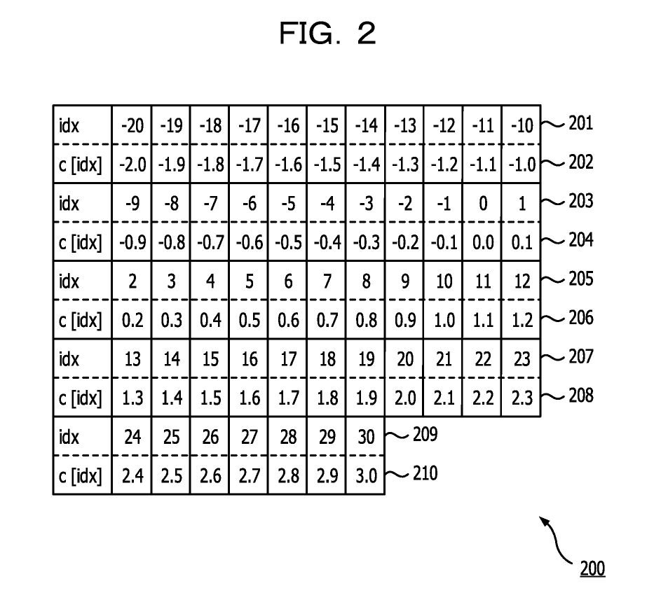

By using predictive coefficients C₁(k) and C₂(k) contained in the codebook, the second downmix unit 13 refers to a quantization table (codebook) indicating a correspondence relationship between representative values of predictive coefficients C₁(k) and C₂(k) held by the second downmix unit 13 and index values. Then, the second downmix unit 13 determines index values most close to predictive coefficients C₁(k) and C₂(k) for the respective frequency bands by referring to the quantization table. Here, a specific example is described. FIG. 2 is a diagram illustrating an example of the quantization table (codebook) relative to the predictive coefficient. In the quantization table 200 illustrated in FIG. 2, fields in columns 201, 203, 205, 207 and 209 represent index values. On the other hand, fields in columns 202, 204, 206, and 208 respectively represent representative values corresponding to index values in fields of columns 201, 203, 205, 207, and 209 in the same row. For example, when the predictive coefficient C₁(k) relative to the frequency band k is 1.2, the second downmix unit 13 sets the index value relative to the predictive coefficient C₁(k) to 12.

Next, the second downmix unit 13 determines a differential value between indexes in the frequency direction for frequency bands. For example, when an index value relative to a frequency band k is 2 and an index value relative to a frequency band (k−1) is 4, the second downmix unit 13 determines that the differential value of the index relative to the frequency band k is −2.

Next, the second downmix unit 13 refers to a coding table indicating a correspondence relationship between the differential value of indexes and predictive coefficient codes. Then, the second downmix unit 13 determines a predictive coefficient code idxcₘ(k)(m=1,2) of the predictive coefficient cₘ(k)(m=1,2) relative to a differential value of frequency bands k by referring to the coding table. Like the similarity code, the predictive coefficient code may be a variable length code having a shorter code length for a differential value of higher appearance frequency, such as, for example, the Huffman coding or the arithmetic coding. The quantization table and the coding table are stored in advance in an unillustrated memory in the second downmix unit 13. In FIG. 1, the second downmix unit 13 outputs the predictive coefficient code idxcₘ(k) (m=1,2) to the spatial information encoding unit 14.

The predictive coefficient code idxcₘ(k)(m=1,2) may be referred to as second spatial information.

The second downmix unit 13 may perform predictive coding based on the energy ratio instead of predictive coding based on the predictive coefficient mentioned above. The second downmix unit 13 calculates, according to the following equation, intensity differences CLD₁(k) and CLD₂(k) relative to three channel frequency signals including the left-channel frequency signal Lᵢₙ(k,n), the right-channel frequency signal Rᵢₙ(k,n), and the center-channel frequency signal Cᵢₙ(k,n), respectively generated by the first downmix unit 12.

$$\begin{matrix}{CLD}_{1} ( k ) = 10 {log}_{10} ( \frac{{}_{}^{e}{Lin}{}_{}^{( k ) + e} {Rin}^{( k )}}{{}_{}^{e}{Cin}{}_{}^{( k )}} ) \\ {CLD}_{2} ( k ) = 10 {log}_{10} ( \frac{{}_{}^{e}{Lin}{}_{}^{( k )}}{{}_{}^{e}{Rin}{}_{}^{( k )}} ) \\ {e}_{Lin} ( k ) = {\sum }_{n = 0}^{N - 1} {\vert {L}_{in} ( k , n ) \vert}^{2} \\ {e}_{Rin} ( k ) = {\sum }_{n = 0}^{N - 1} {\vert {R}_{in} ( k , n ) \vert}^{2} \\ {e}_{Cin} ( k ) = {\sum }_{n = 0}^{N - 1} {\vert {C}_{in} ( k , n ) \vert}^{2}\end{matrix} \qquad ( Equation 12 )$$

The second downmix unit 13 outputs intensity differences CLD₁(k) and CLD₂(k) relative to three channel frequency signals to the spatial information encoding unit 14. Intensity differences CLD₁(k) and CLD₂(k) may be referred to as second spatial information instead of the predictive coefficient code idxcₘ(k)(m=1,2). The second downmix unit 13 outputs the left frequency signal L₀(k,n) and the right frequency signal R₀(k,n) to the frequency-time transformation unit 16. In other words, any two channel signals including a first channel signal and a second channel signal included in multiple channels (5.1 ch) contained in the audio signal are mixed as a downmix signal by the first downmix unit 12 or the second downmix unit 13.

The spatial information encoding unit 14 generates a MPEG Surround code (hereinafter, referred to as a spatial information code) from first spatial information received from the first downmix unit 12 and second spatial information received from the second downmix unit 14.

The spatial information encoding unit 14 refers to the quantization table indicating a correspondence relationship between similarity values in first and second spatial information and index values. Then, the spatial information encoding unit 14 determines an index value most close to the similarity ICCᵢ(k)(i=L,R) for the respective frequency bands by referring to the quantization table. The quantization table may be stored in advance in an unillustrated memory in the spatial information encoding unit 14, and so on.

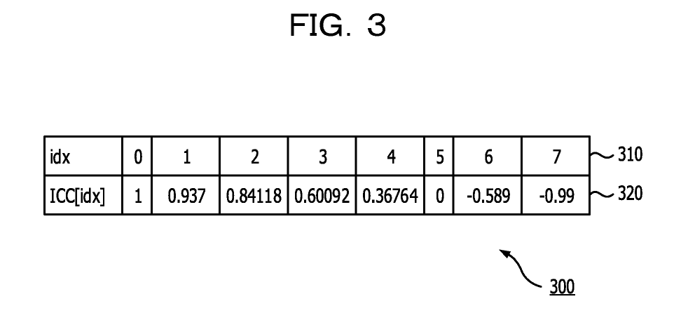

FIG. 3 is a diagram illustrating an example of a quantization table relative to a similarity. In a quantization table 300 illustrated in FIG. 3, each field in the upper row 310 represents an index value, and each field in the lower row 320 represents a representative value of the similarity associated with an index value in the same column. An acceptable value of the similarity is in a range between −0.99 and +1. For example, when the similarity relative to the frequency band k is 0.6, a representative value of a similarity relative to the index value 3 out of those illustrated in the quantization table 300 is most close to the similarity relative to the frequency band k. Thus, the spatial information encoding unit 14 sets the index value relative to the frequency band k to 3.

Next, the spatial information encoding unit 14 determines a differential value between indexes in the frequency direction for frequency bands. For example, when an index value relative to a frequency band k is 3 and an index value relative to a frequency band (k−1) is 0, the spatial information encoding unit 14 determines that the differential value of the index relative to the frequency band k is 3.

The spatial information encoding unit 14 refers to a coding table indicating a correspondence relationship between the differential value of indexes and predictive coefficient codes. Then, the spatial information encoding unit 14 determines the similarity code idxiccᵢ(k)(i=L,R) of the similarity ICCᵢ(k)(i=L,R) relative to the differential value between indexes for frequencies by referring to the coding table. The coding table is stored in advance in a memory in the spatial information encoding unit 14, and so on. The similarity code may be a variable length code having a shorter code length for a differential value of higher appearance frequency, such as, for example, the Huffman coding or the arithmetic coding.

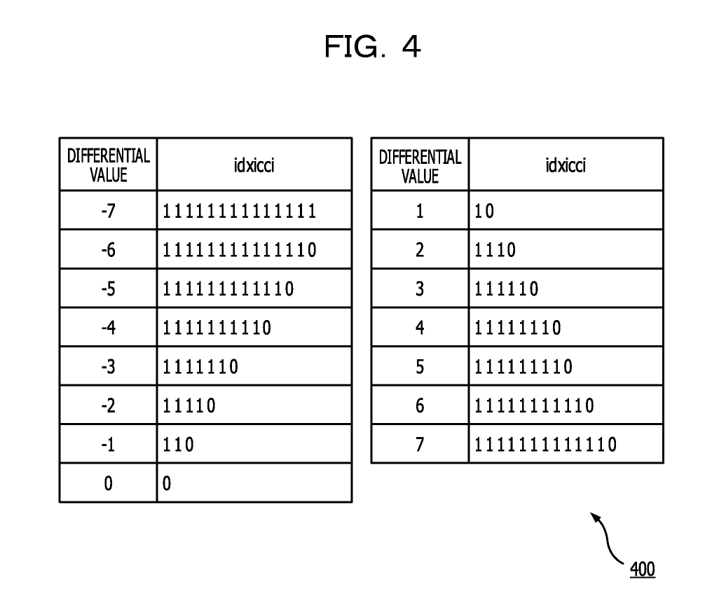

FIG. 4 is an example of a table illustrating a relationship between an index differential value and similarity code. In the example illustrated in FIG. 4, the similarity code is the Huffman coding. In a coding table 400 illustrated in FIG. 4, each field in the left column represents an index differential value, and each field in the right column represents a similarity code associated with an index differential value in the same row. For example, when an index differential value relative to a similarity ICC_{L}(k) of a frequency band k is 3, the spatial information unit 14 sets the similarity code idxicc_{L}(k) relative to the similarity ICC_{L}(k) of the frequency band k to “111110” by referring to the coding table 400.

The spatial information encoding unit 14 refers to a quantization table indicating a correspondence relationship between the intensity differential value and the index value. Then, the spatial information encoding unit 14 determines index values most close to the intensity difference CLDⱼ(k)(j=L,R,C,1,2) for the respective frequency bands by referring to the quantization table. The spatial information encoding unit 14 determines a differential value between indexes in the frequency direction for frequency bands. For example, when an index value relative to a frequency band k is 2 and an index value relative to a frequency band (k−1) is 4, the spatial information encoding unit 14 determines that the differential value of the index relative to the frequency band k is −2.

The spatial information encoding unit 14 refers to a coding table indicating a correspondence relationship between the index-to-index differential value and the intensity code. Then, the spatial information encoding unit 14 determines the intensity difference code idxcldⱼ(k)(j=L,R,C,1,2) relative to the differential value of the intensity difference CLDⱼ(k) for frequency bands k by referring to the coding table. The intensity difference code may be a variable length code having a shorter code length for a differential value of higher appearance frequency, such as, for example, the Huffman coding or the arithmetic coding. The quantization table and the coding table may be stored in advance in a memory in the spatial information encoding unit 14.

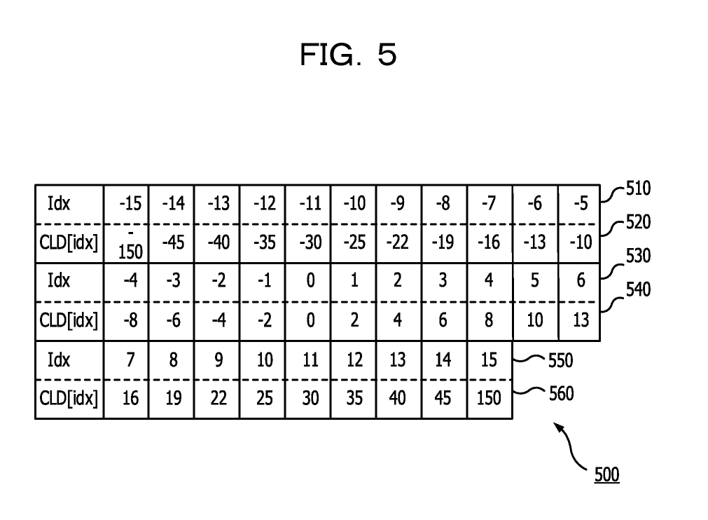

FIG. 5 is a diagram illustrating an example of a quantization table relative to an intensity difference. In a quantization table 500 illustrated in FIG. 5, each field in rows 510, 530 and 550 represents an index value, and each field in rows 520, 540 and 560 represents a representative value of the intensity difference associated with an index value indicated in each field in rows 510, 530 and 550 of the same column. For example, when an intensity difference CLD_{L}(k) relative to the frequency band k is 10.8 dB, a representative value of the intensity difference associated with the index value 5 out of those in the quantization table 500 is most close to CLD_{L}(k). Thus, the spatial information encoding unit 14 sets the index value relative to CLD_{L}(k) to 5.

The spatial information encoding unit 14 generates the similarity code idxiccⱼ(k), the intensity difference code idxcldⱼ, and if desirable, the spatial information code by using the predictive coefficient code idxcₘ(k). For example, the spatial information encoding unit 14 generates the similarity code idxiccᵢ(k) and the intensity difference code idxcldⱼ, and if desirable, also generates the spatial information code by arranging the predictive coefficient code idxcₘ(k) in a predetermined sequence. The predetermined sequence is described, for example, in ISO/IEC23003-1:2007. The spatial information encoding unit 14 outputs the generated spatial information code to the multiplexing unit 19.

The calculation unit 15 receives channel frequency signals (the left front channel frequency signal L(k,n), the left rear channel frequency signal SL(k,n), the right front channel frequency signal R(k,n), and the right rear channel frequency signal SR(k,n)) from the time-frequency transformation unit 11. The calculation unit 15 also receives first spatial information SAC(k) from the first downmix unit 12. The calculation unit 15 calculates, for example, a left-channel residual signal res_{L}(k,n) in accordance with the following equation, from the left front channel frequency signal L(k,n), the left rear channel frequency signal SL(k,n), and the first spatial information SAC(k).

$${res}_{L} = \frac{{H}_{21} \cdot L ( k , n ) - {H}_{11} \cdot SL ( k , n )}{{H}_{21} + {H}_{11}} \\ {H}_{11} = {c}_{1} cos ( α + β ) \\ {H}_{21} = {c}_{2} cos ( - α + β ) \\ {c}_{1} = \sqrt{\frac{{10}^{\frac{{CLD}_{pL}}{10}}}{1 + {10}^{\frac{{CLD}_{pL}}{10}}}} \\ {c}_{2} = \sqrt{\frac{1}{1 + {10}^{\frac{{CLD}_{pL}}{10}}}} \\ α = \frac{1}{2} arccos ( {ICC}_{pL} ) \\ β = arctan \{ tan ( α ) \frac{{c}_{2} - {c}_{1}}{{c}_{2} + {c}_{1}} \} \qquad ( Equation 13 )$$

In Equation 13, CLC_{PL} and ICC_{PL} may be calculated in accordance with the following equations.

CLDₚ(n)=(1−γ(n))×CLD_{L-prev}(k)+γ(n)×CLD_{L-cur}(k)

ICCₚ(n)=(1−γ(n))×ICC_{L-prev}(k)+γ(n)×ICC_{L-cur}(k)

γ(n)=(n+1)/M=(n+1)/31 (Equation 14)

In Equation 14, “n” represents the time, and “w” represents the number of time samples in the frame. CLD_{L-CUR} represents an intensity difference CLD_{L}(k) of a frequency band k for the left channel in a current frame, and CLD_{L-prev} represents an intensity difference CLD_{L}(k) of a frequency band k for the left channel in a preceding frame. CLD_{L-CUR} represents a similarity ICC_{L}(k) of a frequency band k for the left channel in a current frame, and ICC_{L-prev} represents a similarity ICC_{L}(k) of a frequency band k for the left channel in a preceding frame.

Next, the calculation unit 15 calculates a right-channel residual signal res_{R}(k,n) from the right front channel frequency signal R(k,n), the right rear channel frequency signal SR(k,n), and the first spatial information in the same manner as the above-mentioned left-channel residual signal res_{L}(k,n). The calculation unit 15 outputs the calculated left-channel residual signal res_{L}(k,n) and the right-channel residual signal res_{R}(k,n) to the frequency-time transformation unit 16. In Equation 14, γ(n) represents the linear interpolation, which causes a delay corresponding to 0.5 frame time due to the following reason. As may be understood from Equations 13 and 14, the residual signal (left-channel residual signal res_{L}(k,n) or right-channel residual signal res_{R}(k,n)) is calculated from the first spatial information used when decoding with an input signal. The first spatial information used for decoding is calculated by performing the linear interpolation of first spatial information of Nth and (N−1)th frames outputted from the audio encoding device 1. Here, the first spatial information outputted from the audio encoding device 1 has only one value for each frame and each band (frequency band). Hence, since the first spatial information is treated as a central time position of the calculation range (frame), a delay corresponding to 0.5 frames occurs due to the interpolation. Since the delay corresponding to 0.5 frames occurs for treating the first spatial information during decoding as above, a delay corresponding to 0.5 frames also occur when the residual signal is calculated by the calculation unit 15. In other words, the calculation unit 15 calculates residual signals of any two channel signals including a first channel signal and a second channel signal included in multiple channels (5.1 ch) contained in the audio signal.

The frequency-time transformation unit 16 receives the left frequency signal L₀(k,n) and the right frequency signal R₀(k,n) from the second downmix unit 13. The frequency-time transformation unit 16 receives the left-channel residual signal res_{L}(k,n) and the right-channel residual signal res_{R}(k,n) from the calculation unit 15. The frequency-time transformation unit 16 transforms a frequency signal (including residual signal) to a time-domain signal every time receiving the frequency signal. For example, when the time-frequency transformation unit 11 uses a QMF, the frequency-time transformation unit 16 performs frequency-time transformation of the frequency signal by using a complex QMF indicated in the following equation.

$$IQMF ( k , n ) = \frac{1}{64} exp ( j \frac{π}{128} ( k + 0.5 ) ( 2 n - 255 ) ) , \\ 0 \leq k < 64 , \\ 0 \leq n < 128 \qquad ( Equation 15 )$$

Here, IQMF(k,n) is a complex QMF using the time “n” and the frequency “k” as variables. When the time-frequency transformation unit 11 uses another time-frequency transformation processing such as fast Fourier transform, discrete cosine transform, and modified discrete cosine transform, the frequency-time transformation unit 16 uses inverse transformation of the time-frequency transformation processing. The frequency-time transformation unit 16 outputs a time signal of the left frequency signal L₀(k,n) and right frequency signal R₀(k,n) obtained by the frequency-time transformation to the determination unit 17 and the transformation unit 18. The frequency-time transformation unit 16 outputs a time signal of the left-channel residual signal res_{L}(k,n) and the right-channel residual signal res_{R}(k,n) obtained by the frequency-time transformation to the transformation unit 18.

The determination unit 17 receives a time signal of the left frequency signal L₀(k,n) and the right frequency signal R₀(k,n) from the frequency-time transformation unit 16. The determination unit 17 determines a window length from the time signal of the left frequency signal L₀(k,n) and the right frequency signal R₀(k,n). Specifically, the determination unit 17 first determines the perceptual entropy (hereinafter, referred to as “PE”) from a time signal of the left frequency signal L₀(k,n) and the right frequency signal R₀(k,n). PE represents the amount of information for quantizing the frame segment so that the listener (user) will not perceive noise.

The above PE has a property of becoming greater with respect to a sound having a signal level changing sharply in a short time, such as, for example, an attack sound like a sound produced with a percussion instrument. In other words, the determination unit 17 may determine that the window length is a short window length when the downmix signal contains an attack sound and that the window length is a long window length when the downmix signal contains no attack sound. Accordingly, the determination unit 17 provides a shorter window length (higher time resolution with respect to frequency resolution) for a frame segment where PE value becomes relatively greater. Also, the determination unit 17 provides a longer window length (higher frequency resolution with respect to time resolution) for a frame segment where PE value becomes relatively smaller. For example, the short window length contains 128 samples, and the long window length contains 1,024 samples. The determination unit 17 may determine according to the following determination formula whether the window length is short or long.

δPow>Th, then short (short window length)

δPow≦Th, then long (long window length) (Equation 16)

In Equation 16, “Th” represents an optional threshold with respect to the power (amplitude) of time signal (for example, 70% of average power of time signal). “δPow” is, for example, a power difference between adjacent segments in the same frame. The determination unit 17 may apply, for example, a window length determination method disclosed in Japanese Laid-open Patent Publication No. 7-66733. The determination unit 17 outputs a determined window length to the transformation unit 18.

The transformation unit 18 receives the window length from the determination unit 17, and a time signal of the left-channel residual signal res_{L}(k,n) and the right-channel residual signal res_{R}(k,n) from the frequency-time transformation unit 16. The transformation unit 18 receives a time signal of the left frequency signal L₀(k,n) and the right frequency signal R₀(k,n) from the frequency-time transformation unit 16.

First, the transformation unit 18 implements the modified discrete cosine transform (MDCT) as an example of the orthogonal transformation with respect to the time signal of the left frequency signal L₀(k,n) and the right frequency signal R₀(k,n), by using a window length determined by the determination unit 17 to transform the time signal of the left frequency signal L₀(k,n) and the right frequency signal R₀(k,n) to a set of MDCT coefficients. Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a downmix signal code, for example. The transformation unit 18 may perform the modified discrete cosine transform, for example, according to the following equation.

$${MDCT}_{k} = 2 {\sum }_{n = 0}^{N - 1} {w}_{n} \cdot {In}_{n} \cdot cos \{ \frac{2 π}{N} ( n + {n}_{0} ) ( k + \frac{1}{2} ) \} ( 0 \leq k < \frac{N}{2} ) \qquad ( Equation 17 )$$

In Equation 17, MDCT_{K} represents the output MCDT coefficient outputted by the transformation unit 18. Wₙ represents the window coefficient. In represents the input time signal, which is a time signal of the left frequency signal L₀(k,n) or the right frequency signal R₀(k,n). “n” is the time, and “k” is the frequency band. “N” is a constant of the window length multiplied by 2. Further, N₀ is a constant expressed with (N/2+1)/2. The above window coefficient Wₙ is a coefficient corresponding to one of four windows (1. long window length→long window length, 2. long window length→short window length, 3. short window length→short window length, 4. short window length→long window length) defined by combination of a window length of a current frame to be transformed and a window length of a frame ahead (of future). In the orthogonal transformation by the transformation unit 18, a delay corresponding to one frame time occurs since information of the frame window length of a frame ahead (of future) the current frame is used.

Next, the transformation unit 18 performs the modified discrete cosine transform (MDCT transform) (an example of the orthogonal transformation) of a time signal of the left-channel residual signal res_{L}(k,n) and the left-channel residual signal res_{R}(k,n) by using a window length determined by the determination unit 17 as is to transform the time signal of the left-channel residual signal res_{L}(k,n) and left-channel residual signal res_{R}(k,n) to a set of MDCT coefficients. Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a residual signal code, for example. The transformation unit 18 may perform the modified discrete cosine transform of a time signal of the left-channel residual signal res_{L}(k,n) and the right-channel residual signal res_{R}(k,n) by using Equation 17 in the same manner as the left frequency signal L₀(k,n) and the right frequency signal R₀(k,n). In this case, the input time signal Inₙ is a time signal of the left-channel residual signal res_{L}(k,n) and the right-channel residual signal res_{R}(k,n). Further, the window coefficient Wₙ used in the modified discrete cosine transform of the left frequency signal L₀(k,n) and the right frequency signal Rₒ(k,n) is used as is. Consequently, in the orthogonal transformation of the time signal of the left-channel residual signal res_{L}(k,n) and the right-channel residual signal res_{R}(k,n), a delay corresponding to one frame time does not occur since information of the frame window length of a frame ahead (of future) the current frame is not used.

When transforming the downmix signal code to a residual signal code, the transformation unit 18 performs orthogonal transformation by adjusting delay amounts of the downmix signal code and the residual signal code in such a manner that the delay amounts synchronize with each other, due to the following reason. When delay amounts of the downmix signal code and the residual signal code are not synchronized on the side of the audio encoding device 1, the delay amounts are outputted to the audio decoding device without being synchronized. A typical audio decoding device is configured not to perform correction of the time position. Accordingly, it is difficult to decode an original sound source since decoding is performed using a downmix signal code and a residual signal code at a time position different from the original sound source. Accordingly, delay amounts of the downmix signal code and the residual signal code have to be synchronized on the side of the audio encoding device 1. The delay amounts of the downmix signal code and the residual signal code may be synchronized when the transformation unit 18 outputs the downmix signal code and the residual signal code to the multiplexing unit 19. Further, the delay amounts may be synchronized when the multiplexing unit 19 performs multiplexing described later. Further, the transformation unit 18 may include a buffer such as an unillustrated cache and memory to synchronize the delay amounts of the downmix signal code and the residual signal code.

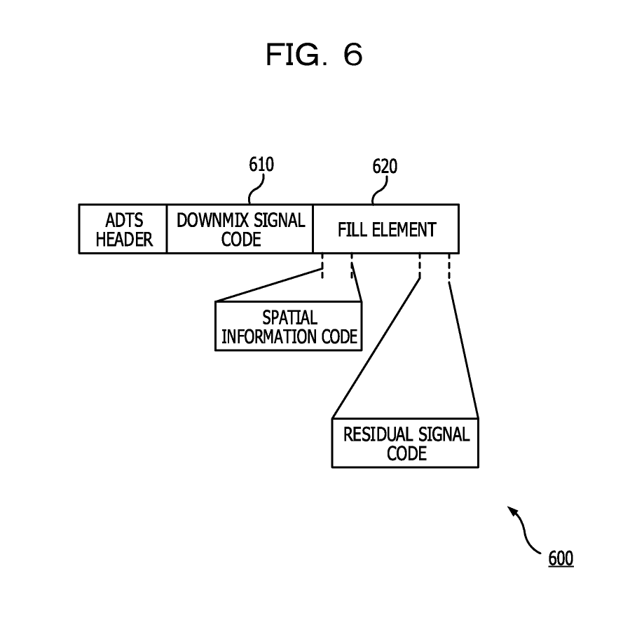

The multiplexing unit 19 receives the downmix signal code and the residual signal code from the transformation unit 18. Also, the multiplexing unit 19 receives the spatial information code from the spatial information encoding unit 14. The multiplexing unit 19 multiplexes the downmix signal code, the spatial information code, and the residual signal code by arranging in a predetermined sequence. Then, the multiplexing unit 19 outputs an encoded audio signal generated by multiplexing. FIG. 6 is a diagram illustrating an example of a data format in which an encoded audio signal is stored. In the example illustrated in FIG. 6, the encoded audio signal is produced in accordance with the MPEG-4 Audio Data Transport Stream (ADTS) format. The downmix signal code of the encoded data string 600 illustrated in FIG. 6 is stored in the data block 610. The spatial information code and the residual signal code are stored in a partial area of the block 620 in which a FILL element in the ADTS format is stored.

Here, an example of technical significances in Embodiment 1 is described. Although described in detail in Comparative Example later, typically, a window length of the left-channel residual signal res_{L}(k,n) and the right-channel residual signal re res_{R}(k,n) have to be calculated by using Equation 16 from a time signal of the left-channel residual signal res_{L}(k,n) and the right-channel residual signal res_{R}(k,n). Further, orthogonal transformation (for example, modified discrete cosine transform) of a time signal of the left-channel residual signal res_{L}(k,n) and the right-channel residual signal res_{R}(k,n) have to be performed by using Equation 17 in the same manner as the time signal of the left frequency signal L₀(k,n) and the right frequency signal R₀(k,n). Consequently, in the orthogonal transformation of the left-channel residual signal res_{L}(k,n) and the right-channel residual signal res_{R}(k,n), a delay corresponding to one frame time occurs for information of the frame window length of a frame ahead (of future) the current frame.

However, in Embodiment 1, the transformation unit 18 performs modified discrete cosine transform of a time signal of the left-channel residual signal res_{L}(k,n) and the right-channel residual signal res_{R}(k,n), as described above, by using the window coefficient Wₙ used in the modified discrete cosine transform of the left frequency signal L₀(k,n) or the right frequency signal R₀(k,n), as is. Consequently, in the orthogonal transformation of the time signal of the left-channel residual signal res_{L}(k,n) and the right-channel residual signal res_{R}(k,n), there is an advantage that a delay corresponding to one frame time does not occur since information of the frame window length of a frame ahead (of future) the current frame is not used.

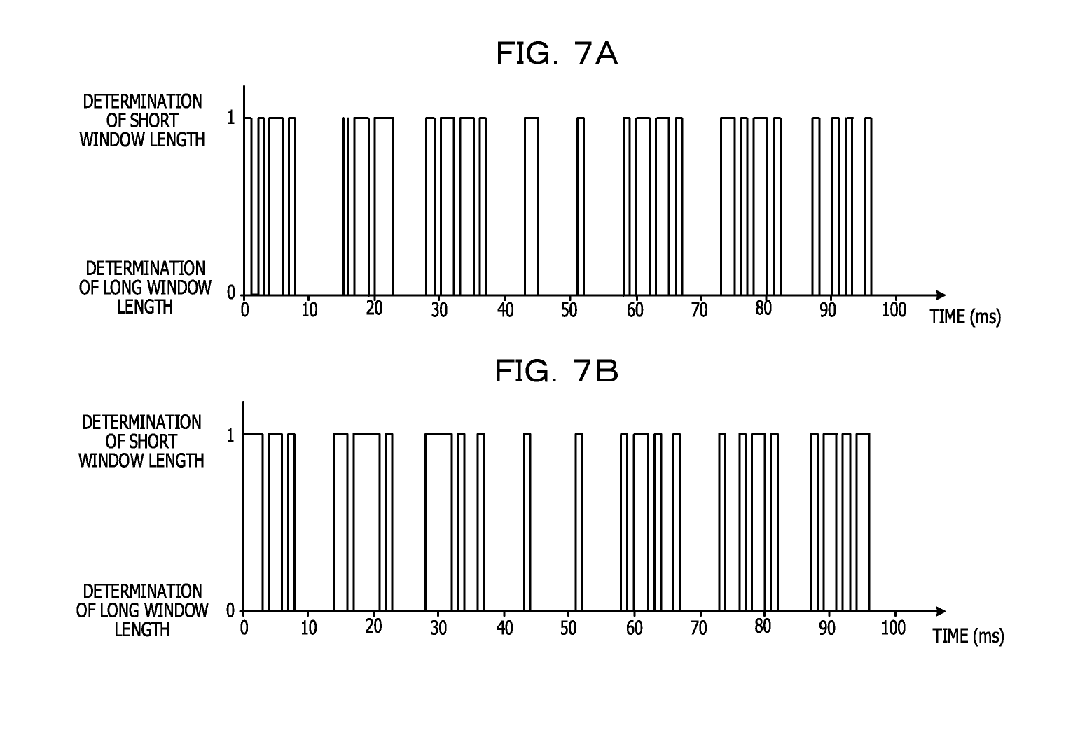

Next, technical reason is described as to why the transformation unit 18 may use the window coefficient Wₙ used in the modified discrete cosine transform of the left frequency signal L₀(k,n) or the right frequency signal R₀(k,n), as is, when performing modified discrete cosine transform of a time signal of the left-channel residual signal res_{L}(k,n) and the right-channel residual signal res_{R}(k,n) in Embodiment 1. The technical reason was newly found as a result of intensive studies by the inventors. FIG. 7A is a diagram illustrating window length determination results of a time signal of a left frequency signal L₀(k,n) and a right frequency signal R₀(k,n). FIG. 7B is a diagram illustrating window length determination results of the time signal of the left-channel residual signal res_{L}(k,n) and the right-channel residual signal res_{R}(k,n). FIGS. 7A and 7B depict window length determination results according to Equation 17. The horizontal axis represents the time, and the vertical axis represents the determination result. “0” indicates determination of the long window length, and “1” indicates determination of the short window length. In FIGS. 7A and 7B, a calculated matching rate of long and short window lengths at respective times is higher than 90%, from which it was newly found that there is a strong correlation between the window lengths. In other words, since there is a strong correlation between a window length of the time signal of the left frequency signal L₀(k,n) and the right frequency signal R₀(k,n) and a time signal of the left-channel residual signal res_{L}(k,n) and the right-channel residual signal res_{R}(k,n), one of the window lengths (or window coefficients Wₙ) may be used as the other thereof.

Technical consideration by the inventors on the above-mentioned new finding is described below. The left frequency signal L₀(k,n) and the right frequency signal R₀(k,n) are signals in which a direct wave with respect to an input sound source is modeled. On the other hand, the left-channel residual signal res_{L}(k,n) and the right-channel residual signal res_{R}(k,n) are signals in which a reflected wave (echo sound such as, for example, echo reflected in indoor environment) with respect to an input sound source is modeled. Since being the same input sound source originally, both frequency signals (left frequency signal L₀(k,n) and right frequency signal R₀(k,n)) and residual signals (left-channel residual signal res_{L}(k,n) and right-channel residual signal res_{R}(k,n)) include sounds having a property of becoming greater with respect to a sound whose signal level varies sharply in a short time, such as an attack sound generated by a percussion instrument, although there exists a phase difference and a power difference therebetween. When a window length determination is performed with thresholds used in Equation 16 under such conditions, influences of the phase difference and power difference would be converged by thresholds and there would be a relationship of a strong correlation between the frequency signal and the residual signal.

### COMPARATIVE EXAMPLE

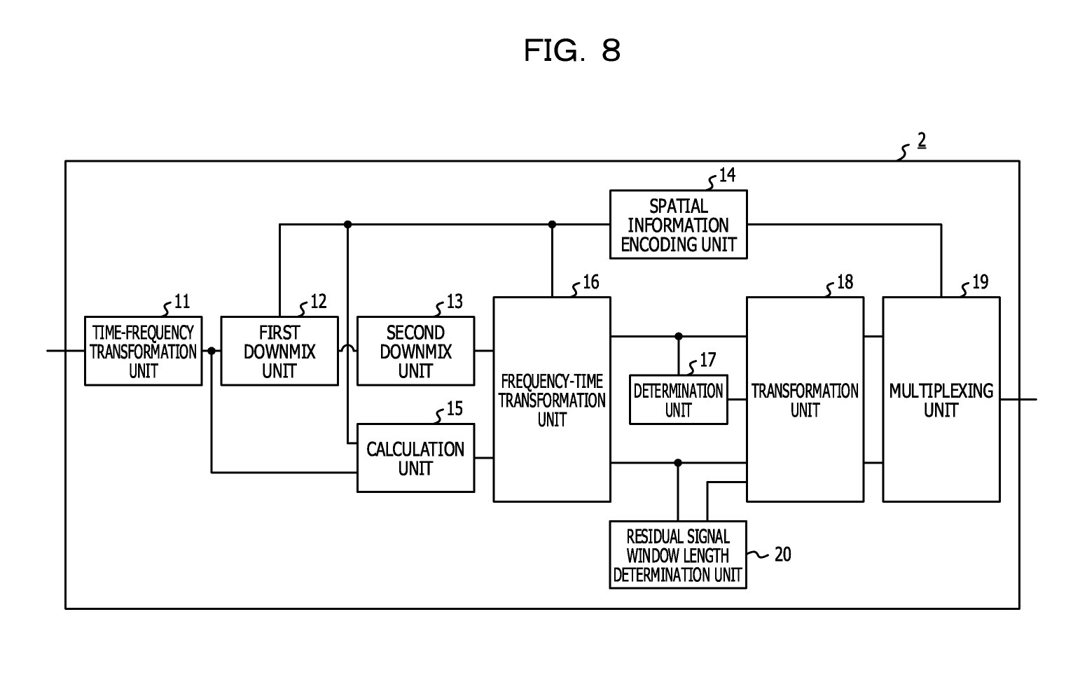

FIG. 8 is a functional block diagram of an audio encoding device according to one embodiment (comparative example). An audio encoding device 2 illustrated in FIG. 8 is Comparative Example corresponding to Embodiment 1. As illustrated in FIG. 8, the audio encoding device 2 includes a time-frequency transformation unit 11, a first downmix unit 12, a second downmix unit 13, a spatial information encoding unit 14, a calculation unit 15, a frequency-time transformation unit 16, a determination unit 17, a transformer 18, a multiplexing unit 19, and a residual signal window length determination unit 20. In FIG. 8, detailed description of the time-frequency transformation unit 11, the first downmix unit 12, the second downmix unit 13, the spatial information encoding unit 14, the calculation unit 15, the determination unit 17, and the multiplexing unit 19 is omitted since functions thereof are the same as those in FIG. 1.

In FIG. 8, the frequency-time transformation unit 16 outputs a time signal of the left frequency signal L₀(k,n) and right frequency signal R₀(k,n) obtained by the frequency-time transformation in the same manner as Embodiment 1 to the determination unit 17 and the transformation unit 18. The frequency-time transformation unit 16 outputs a time signal of the left-channel residual signal res_{L}(k,n) and right-channel residual signal res_{R}(k,n) obtained by the frequency-time transformation in the same manner as Embodiment 1 to the transformation unit 18 and the residual signal window length determination unit 20.

The residual signal window length determination unit 20 receives a time signal of the left-channel residual signal res_{L}(k,n) and right-channel residual signal res_{R}(k,n) from the frequency-time transformation unit 16. The residual signal window length determination unit 20 calculates a window length of the left-channel residual signal res_{L}(k,n) and the right-channel residual signal res_{R}(k,n) from the time signal of the left-channel residual signal res_{L}(k,n) and the right-channel residual signal res_{R}(k,n) by using Equation 16. The residual signal window length determination unit 20 outputs the window length of the left-channel residual signal res_{L}(k,n) and right-channel residual signal res_{R}(k,n) to the transformation unit 18.

The transformation unit 18 receives the time signal of the left frequency signal L₀(k,n) and right frequency signal R₀(k,n), and the time signal of the left-channel residual signal res_{L}(k,n) and the right-channel residual signal res_{R}(k,n) from the frequency-time transformation unit 16. The transformation unit 18 receives the window length of the time signal of the left frequency signal L₀(k,n) and the right frequency signal R₀(k,n) from the determination unit 17. Further, the transformation unit 18 receives the window length of the time signal of the left-channel residual signal res_{L}(k,n) and right-channel residual signal res_{R}(k,n) from the residual signal window length determination unit 20.

The transformation unit 18 transforms the time signal of the left frequency signal L₀(k,n) and the right frequency signal R₀(k,n) to a set of MDCT coefficients through orthogonal transformation in the same manner as Embodiment 1. Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a downmix signal code.

The transformation unit 18 transforms the time signal of the left-channel residual signal res_{L}(k,n) and right-channel residual signal res_{R}(k,n) to a set of MDCT coefficients through orthogonal transformation. Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a residual signal code, for example.

Specifically, the transformation unit 18 have to perform orthogonal transformation of the time signal of the left-channel residual signal res_{L}(k,n) and the right-channel residual signal res_{R}(k,n) with the window length of the left-channel residual signal res_{L}(k,n) and the right-channel residual signal res_{R}(k,n), by using Equation 17 in the same manner as the time signal of the left frequency signal L₀(k,n) and the right frequency signal R₀(k,n). Consequently, in the orthogonal transformation of the left-channel residual signal res_{L}(k,n) and the right-channel residual signal res_{R}(k,n), a delay corresponding to one frame time also occurs since information of the frame window length of a frame ahead (of future) the current frame is used. When transforming the downmix signal code to a residual signal code, the transformation unit 18 have to perform orthogonal transformation by adjusting delay amounts of the downmix signal code and the residual signal code in such a manner that the delay amounts synchronize with each other, similarly with Embodiment 1.

Here, delay amounts of the comparative Embodiment 1 and Embodiment 1 are compared with each other. First, in the calculation unit 15 illustrated in FIGS. 1 and 8, a delay corresponding to 0.5 frame time occurs (the delay amount may be referred to as a second delay amount). The delay corresponding to 0.5 frame time corresponds to a delay of the residual signal code. Next, in the transformation unit 18 illustrated in FIG. 1, a delay corresponding to one frame time occurs for selection of the window coefficient Wₙ when performing orthogonal transformation of the left frequency signal L₀(k,n) and the right frequency signal R₀(k,n), as described above (the delay amount may be referred to as a first delay amount). The delay corresponding to one frame time corresponds to a delay of the downmix signal code. In the transformation unit 18 illustrated in FIG. 8, a delay corresponding to one frame time occurs when performing orthogonal transformation of the left frequency signal L₀(k,n) and the right frequency signal R₀(k,n). Further, in addition to the delay, a delay corresponding to one frame time occurs when performing orthogonal transformation of the left-channel residual signal res_{L}(k,n) and the right-channel residual signal res_{R}(k,n). The delay corresponding to one frame time corresponds to a delay of the residual signal code. Additionally, entire delay amount of the residual signal code in the comparative Embodiment 1 is a sum of delay amounts of the calculation unit 15 and the transformation unit 18, which corresponds to 1.5 frame time.

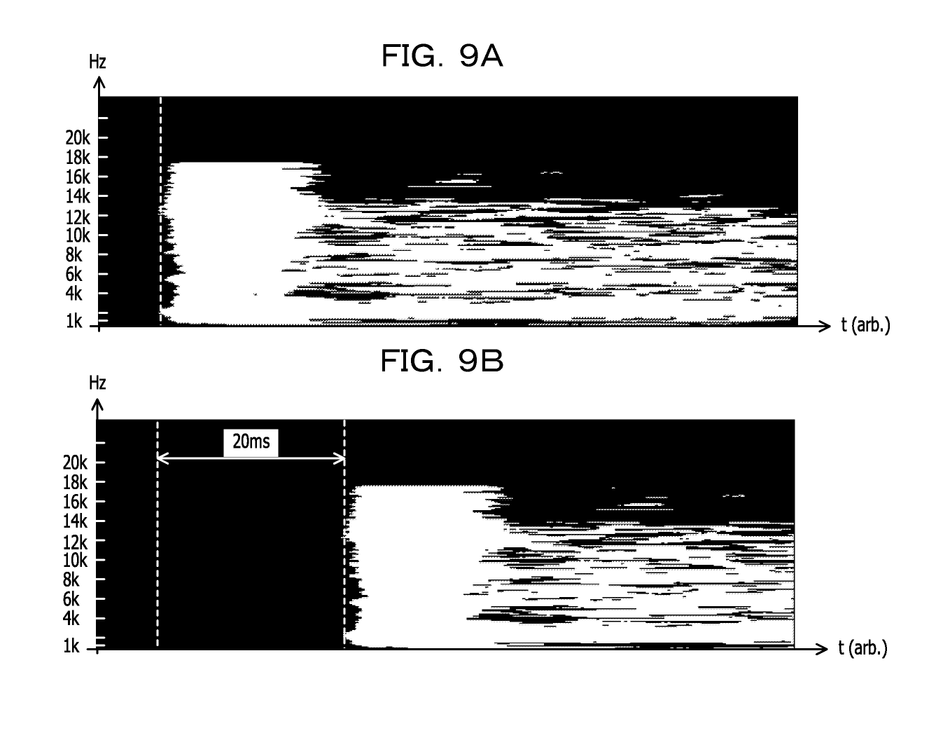

To synchronize delay amounts of the downmix signal code and the residual signal code, the delay have to be adjusted to a larger one. Accordingly, a delay amount according to Embodiment 1 corresponds to 1 frame time, and a delay amount according to Comparative Example 1 corresponds to 1.5 frame time. Accordingly, the audio encoding device 1 according to Embodiment 1 is capable of reducing the delay amount. FIG. 9A is a conceptual diagram of the delay amount of a multi-channel audio signal in Embodiment 1. FIG. 9B is a conceptual diagram of the delay amount of a multi-channel audio signal in Comparative Example 1. In spectrum diagrams of FIGS. 9A and 9B, the vertical axis represents the frequency, and the horizontal axis represents the sampling time. In Embodiment 1, a reduction of the delay amount less by 20 ms than Comparative Example 1 was verified.

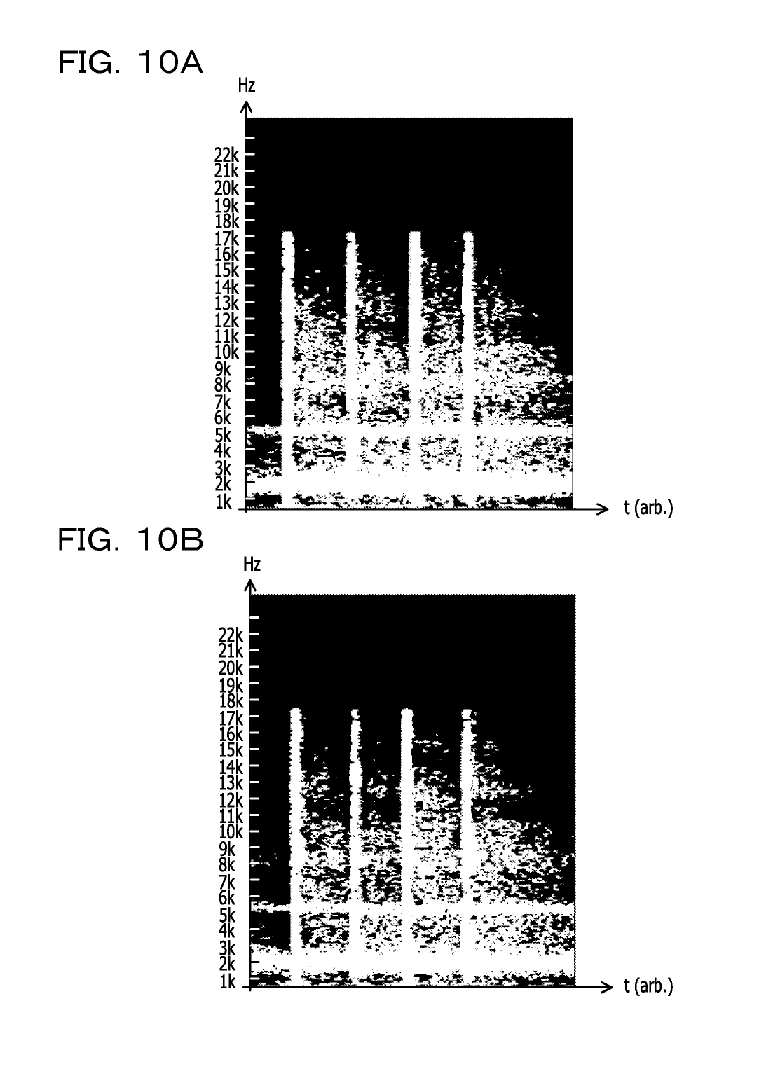

FIG. 10A is a spectrum diagram of a decoded multi-channel audio signal to which a coding of Embodiment 1 is applied.

FIG. 10B is a spectrum diagram of a decoded multi-channel audio signal to which a coding of Comparative Example 1 is applied. In spectrum diagrams of FIGS. 10A and 10B, the vertical axis represents the frequency, and the horizontal axis represents the sampling time. As may be understood by comparing FIGS. 10A and 10B to each other, reproduction (decoding) of an audio signal approximately the same as a spectrum of Comparative Example 1 was verified when coding is performed by applying Embodiment 1. Accordingly, the audio encoding device 1 according to Embodiment 1 is capable of reducing the delay amount without degrading the sound quality. Further, the audio encoding device 1 according to Embodiment 1 also provides a synergistic effect of reducing computation load since window length calculation of the time signal of the left-channel residual signal res_{L}(k,n) and the right-channel residual signal res_{R}(k,n) is not performed.

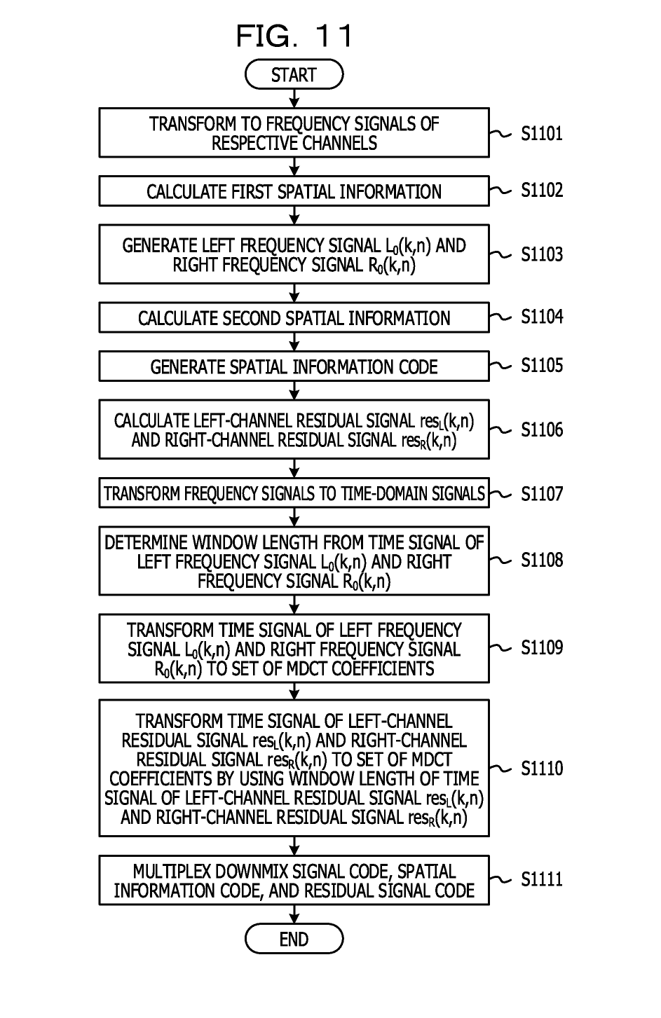

FIG. 11 is an operation flowchart of audio coding.

The flowchart illustrated in FIG. 11 represents processing of the multi-channel audio signal for one frame. The audio encoding device 1 repeatedly implements audio coding illustrated in FIG. 11 on the frame by frame basis while the multi-channel audio signal is being received.

The time-frequency transformation unit 11 is configured to transform signals of the respective channels (for example, signals in 5.1 ch) in the time domain of multi-channel audio signals entered to the audio encoding device 1 to frequency signals of the respective channels by time-frequency transformation on the frame by frame basis (step S1101). Every time calculating frequency signals of the respective channels on the frame by frame basis, the time-frequency transformation unit 11 outputs frequency signals (for example, the frequency signal of the left front channel L(k,n), the frequency signal of the left rear channel SL(k,n), the frequency signal of the right front channel R(k,n), the frequency signal of the right rear channel SR(k,n), the frequency signal of the center-channel C(k,n), and the frequency signal of the deep bass sound channel LFE(k,n)) to the first downmix unit 12 and the calculation unit 15.

The first downmix unit 12 is configured to generate left-channel, center-channel and right-channel frequency signals by downmixing frequency signals of the respective channels every time receiving from the time-frequency transformation unit 11. The first downmix unit 12 calculates, on the frequency band basis, an intensity difference between frequency signals of two channels to be downmixed, and a similarity (which may be referred to as a first spatial information SAC(k)) between the frequency signals, as spatial information between the frequency signals. The intensity difference is information representing the sound localization, and the similarity turns information representing the sound spread (step S1102). The spatial information calculated by the first downmix unit 12 is an example of three-channel spatial information. In Embodiment 1, the first downmix unit 12 calculates the first spatial information SAC(k) in accordance with Equations 3 to 7. The first downmix unit 12 outputs the left-channel frequency signal Lᵢₙ(k,n), the right-channel frequency signal Rᵢₙ(k,n), and the center-channel frequency signal Cᵢₙ(k,n), which are generated by downmixing, to the second downmix unit 13, and outputs the first spatial information SAC(k) to the spatial information encoding unit 14 and the calculation unit 15.

The second downmix unit 13 receives three-channel frequency signals including the left-channel frequency signal Lᵢₙ(k,n), the right-channel frequency signal Rᵢₙ(k,n), and the center-channel frequency signal Cᵢₙ(k,n), respectively generated by the first downmix unit 12. The second downmix unit 13 generates a left frequency signal L₀(k,n) in the stereo frequency signal by downmixing the left-channel frequency signal and the center-channel frequency signal out of the three-channel frequency signals. Further, the second downmix unit 13 generates a right frequency signal in the stereo frequency signal by downmixing the right-channel frequency signal and the center-channel frequency signal (step S1103). The second downmix unit 13 generates, for example, a left frequency signal L₀(k,n) and a right frequency signal R₀(k,n) in the stereo frequency signal in accordance with the Equation 8. Further, the second downmix unit calculates the predictive coefficient code idxcm(k)(m=1,2) or the intensity differences CLD1(k) and CLD2(k) as second spatial information, by using the above method (step S1104). The second downmix unit 13 outputs the second spatial information to the spatial information encoding unit 14. The second downmix unit 13 outputs the left frequency signal L₀(k,n) and the right frequency signal R₀(k,n) to the frequency-time transformation unit 16.

The spatial information encoding unit 14 generates a spatial information code from the first spatial information received from the first downmix unit 12 and the second spatial information received from the second downmix unit 14 (step S1105). The spatial information encoding unit 14 outputs the generated spatial information code to the multiplexing unit 19.

The calculation unit 15 receives frequency signals of the respective channels (the left front channel frequency signal L(k,n), the left rear channel frequency signal SL(k,n), the right front channel frequency signal R(k,n), and the right rear channel frequency signal SR(k,n)) from the time-frequency transformation unit 11. The calculation unit 15 also receives first spatial information SAC(k) from the first downmix unit 12. The calculation unit 15 calculates, for example, a left-channel residual signal res_{L}(k,n) from the left front channel frequency signal L(k,n), the left rear channel frequency signal SL(k,n), and the first spatial information SAC(k) in accordance with above Equations 13 and 14. Next, the calculation unit 15 calculates a right-channel residual signal res_{R}(k,n) from the right front channel frequency signal R(k,n), the right rear channel frequency signal RL(k,n), and the first spatial information in the same manner as the above-mentioned left-channel residual signal res_{L}(k,n) (step S1106). The calculation unit 15 outputs the calculated left-channel residual signal res_{L}(k,n) and the right-channel residual signal res_{R}(k,n) to the frequency-time transformation unit 16.

The frequency-time transformation unit 16 receives the left frequency signal L₀(k,n) and the right frequency signal R₀(k,n) from the second downmix unit 13. The frequency-time transformation unit 16 receives the left-channel residual signal res_{L}(k,n) and the right-channel residual signal res_{R}(k,n) from the calculation unit 15. The frequency-time transformation unit 16 transforms frequency signals (including residual signals) to time-domain signals every time receiving the frequency signals (step S1107). The frequency-time transformation unit 16 outputs the time signal of the left frequency signal L₀(k,n) and right frequency signal R₀(k,n) obtained by the frequency-time transformation to the determination unit 17 and the transformation unit 18. The frequency-time transformation unit 16 outputs time signals of the left residual signal res_{L}(k,n) and right residual signal res_{R}(k,n) obtained by the frequency-time transformation to the transformation unit 18.

The determination unit 17 receives the time signals of the left frequency signal L₀(k,n) and the right frequency signal R₀(k,n) from the frequency-time transformation unit 16. The determination unit 17 determines the window length from the time signals of the left frequency signal L₀(k,n) and the right frequency signal R₀(k,n) (step S1108). The determination unit 17 outputs the determined window length to the transformation unit 18.

The transformation unit 18 receives the window length from the determination unit 17, and the time signals of the left-channel residual signal res_{L}(k,n) and right-channel residual signal res_{R}(k,n) from the frequency-time transformation unit 16. The transformation unit 18 receives the time signals of the left frequency signal L₀(k,n) and the right frequency signal R₀(k,n) from the frequency-time transformation unit 16. The transformation unit 18 implements the modified discrete cosine transform (MDCT), which is an example of the orthogonal transformation, with respect to the time signals of the left frequency signal L₀(k,n) and the right frequency signal R₀(k,n), by using the window length determined by the determination unit 17 to transform the time signals of the left frequency signal L₀(k,n) and the right frequency signal R₀(k,n) to a set of MDCT coefficients (step S1109). Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a downmix signal code. The transformation unit 18 may perform the modified discrete cosine transform, for example, according to Equation 17.

Next, the transformation unit 18 performs the modified discrete cosine transform (MDCT transform) (an example of the orthogonal transformation) of the time signal of the left-channel residual signal res_{L}(k,n) and right-channel residual signal res_{R}(k,n) by using the window length determined by the determination unit 17 as is to transform the time signals of the left-channel residual signal res_{L}(k,n) and the right-channel residual signal res_{R}(k,n) to a set of MDCT coefficients (step S1110). Further, the transformation unit 18 quantizes the set of MDCT coefficients and performs variable-length coding of the set of quantized MDCT coefficients. The transformation unit 18 outputs the set of MDCT coefficients subjected to the variable-length coding and relevant information such as quantization coefficients to the multiplexing unit 19, as a residual signal code, for example. The transformation unit 18 may perform the modified discrete cosine transform of the time signals of the left-channel residual signal res_{L}(k,n) and the right-channel residual signal res_{R}(k,n) by using Equation 17 in the same manner as the left frequency signal L₀(k,n) and the right frequency signal R₀(k,n). When transforming to a downmix signal code and a residual signal code, the transformation unit 18 performs orthogonal transformation by adjusting delay amounts of the downmix signal code and the residual signal code in such a manner that the delay amounts synchronize with each other.

The multiplexing unit 19 receives the downmix signal code and the residual signal code from the transformation unit 18. Also, the multiplexing unit 19 receives the spatial information code from the spatial information encoding unit 14. The multiplexing unit 19 multiplexes the downmix signal code, the spatial information code, and the residual signal code by arranging in a predetermined sequence (step S1111). Then, the multiplexing unit 19 outputs the encoded audio signal generated by multiplexing. Now, the audio encoding device 1 ends processing illustrated in the operation flowchart of the audio coding in FIG. 11.

### Embodiment 2

In Embodiment 1, relation of strong correlation is described between the frequency signal (left frequency signal L₀(k,n) and right frequency signal R₀(k,n)) and the residual signal (left-channel residual signal res_{L}(k,n) and right-channel residual signal res_{R}(k,n)). Here, Embodiment 2 capable of reducing computation load of an audio encoding device by utilizing the technical feature is described. Illustration of Embodiment 2 is omitted since functional blocks of an audio encoding device according to Embodiment 2 are the same as those of the audio encoding device illustrated in FIG. 8 except the determination unit 17 which is not included in Embodiment 2.

The transformation unit 18 performs the modified discrete cosine transform (MDCT transform) (an example of the orthogonal transformation) of time signals of the left-channel residual signal res_{L}(k,n) and left-channel residual signal res_{R}(k,n) by using a window length determined by the residual signal window length determination unit 20 to transform the time signals of the left-channel residual signal res_{L}(k,n) and left-channel residual signal res_{R}(k,n) to a set of MDCT coefficients.

Next, the transformation unit 18 implements the modified discrete cosine transform as an example of the orthogonal transformation with respect to the time signals of the left frequency signal L₀(k,n) and the right frequency signal R₀(k,n), by using a window length determined by the residual signal window length determination unit 20 as is to transform the time signals of the left frequency signal L₀(k,n) and the right frequency signal R₀(k,n) to a set of MDCT coefficients. This makes unnecessary the window length determination of the time signals of the left frequency signal L₀(k,n) and the right frequency signal R₀(k,n) in the determination unit 17 and thus reduces computation load of the audio encoding device.

### Embodiment 3

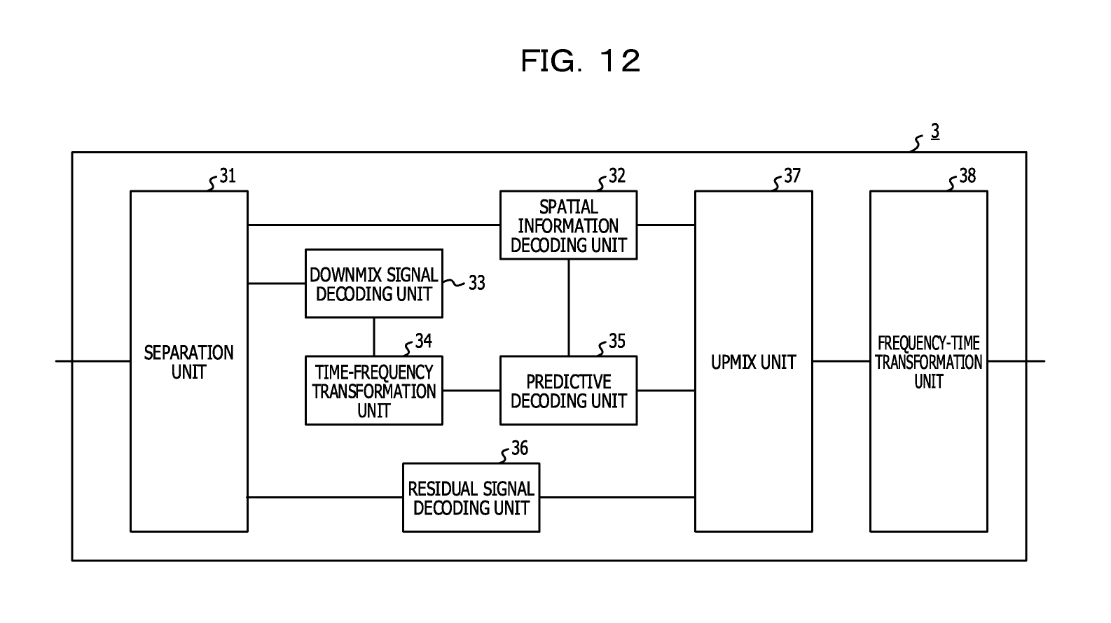

FIG. 12 is a functional block diagram of an audio decoding device 3 according to one embodiment. As illustrated in FIG. 12, the audio decoding device 3 includes a separation unit 31, a spatial information decoding unit 32, a downmix signal decoding unit 33, a time-frequency transformation unit 34, a predictive decoding unit 35, a residual signal decoding unit 36, an upmix unit 37, and a frequency-time transformation unit 38.

These components included in the audio decoding device 3 are formed, for example, as separate hardware circuits using wired logic. Alternatively, these components included in the audio decoding device 3 may be implemented into the audio decoding device 3 as one integrated circuit in which circuits corresponding to respective components are integrated. The integrated circuit may be an integrated circuit such as, for example, application specific integrated circuit (ASIC) and field programmable gate array (FPGA). Further, these components included in the audio decoding device 3 may be function modules which are achieved by a computer program implemented on a processor of the audio decoding device 3.

The separation unit 31 receives a multiplexed encoded audio signal from the outside. The separation unit 31 separates the encoded downmix signal code, the spatial information code, and the residual signal code, which are contained in the encoded audio signal. The separation unit 31 is capable of using, for example, a method described in ISO/IEC14496-3 as a separation method. The separation unit 31 outputs a separated spatial information code to the spatial information decoding unit 32, a downmix signal code to the downmix signal decoding unit 33, and a residual signal code to the residual signal decoding unit 36.

The spatial information decoding unit 32 receives the spatial information code from the separation unit 31. The spatial information decoding unit 32 decodes the similarity ICCᵢ(k) from the spatial information code by using an example of the quantization table relative to the similarity illustrated in FIG. 3, and outputs the decoded similarity to the upmix unit 37. The spatial information decoding unit 32 decodes the intensity difference CLDⱼ(k) by using an example of the quantization table relative to the intensity difference illustrated in FIG. 5, and outputs the decoded intensity difference to the upmix unit 37. In other words, the spatial information decoding unit 32 outputs the first spatial information SAC(k) to the upmix unit 37, and outputs the intensity differences CLD₁(k) and CLD₂(k) to the predictive decoding unit 35 when the intensity differences CLD₁(k) and CLD₂(k) are decoded as the second spatial information. When the predictive coefficient code idxcₘ(k)(m-1,2) is received from the separation unit 31 as the second spatial information, the spatial information decoding unit 32 decodes the predictive coefficient from the spatial information code by using an example of the quantization table relative to the predictive coefficient illustrated in FIG. 2, and outputs the decoded predictive coefficient to the predictive decoding unit 35, as appropriate.

The downmix signal decoding unit 33 receives a downmix signal code from the separation unit 31, decodes signals (downmix signals) of the respective channels, for example, according to an MC decoding method, and outputs to the time-frequency transformation unit 34. The downmix signal decoding unit 33 may use, for example, a method described in ISO/IEC13818-7 as the MC decoding method.

The time-frequency transformation unit 34 transforms signals of the respective channels being a time signal decoded by the downmix signal decoding unit 33 to a frequency signal, for example, by using a QMF described in ISO/IEC14496-3, and outputs to the predictive decoding unit 35. The time-frequency transformation unit 34 may perform time-frequency transformation by using a complex QMF illustrated in the following equation.

$$QMF ( k , n ) = exp ( j \frac{π}{128} ( k + 0.5 ) ( 2 n + 1 ) ) , \\ 0 \leq k < 64 , \\ 0 \leq n < 128 \qquad ( Equation 18 )$$

Here, QMF(k,n) is a complex QMF using the time “n” and the frequency “k” as variables. The time-frequency transformation unit 34 outputs time frequency signals of the respective channels to the predictive decoding unit 35.

The predictive decoding unit 35 performs predictive decoding of the center-channel signal C₀(k,n) predictively encoded from a predictive coefficient received from the spatial information decoding unit 32 as appropriate, and a frequency signal received from the time-frequency transformation unit 34. For example, the predictive decoding unit 35 is capable of predictively decoding the center-channel signal C₀(k,n) from a stereo frequency signal and predictive coefficients C₁(k) and C₂(k) of the left frequency signal L₀(k,n) and right frequency signal R₀(k,n) according to the following equation.

C₀(k,n)=c₁(k)·L₀(k,n)+c₂(k)·R₀(k,n) (Equation 19)

When intensity differences CLD₁(k) and CLD₂(k) are received from the spatial information decoding unit 32 instead of the predictive coefficients, the predictive decoding unit 35 may predictively decodes the center-channel signal C₀(k,n) by using Equation 19. The predictive decoding unit 35 outputs the left frequency signal L₀(k,n), the right frequency signal R₀(k,n), and the central frequency signal C₀(k,n) to the upmix unit 37.

The residual signal decoding unit 36 receives a residual signal code from the separation unit 31. The residual signal decoding unit 36 decodes the residual signal code, and outputs decoded residual signals (the left-channel residual signal res_{L}(k,n) and the right-channel residual signal res_{R}(k,n)) to the upmix unit 37.

The upmix unit 37 performs matrix transformation according to the following equation for the left frequency signal L₀(k,n), the right frequency signal R₀(k,n), and the central frequency signal C₀(k,n), received from the predictive decoding unit 35.

$$( \begin{matrix}{L}_{out} ( k , n ) \\ {R}_{out} ( k , n ) \\ {C}_{out} ( k , n )\end{matrix} ) = \frac{1}{3} ( \begin{matrix}2 & - 1 & 1 \\ - 1 & 2 & 1 \\ \sqrt{2} & \sqrt{2} & - \sqrt{2}\end{matrix} ) ( \begin{matrix}{L}_{0} ( k , n ) \\ {R}_{0} ( k , n ) \\ {C}_{0} ( k , n )\end{matrix} ) \qquad ( Equation 20 )$$

Here, Lₒᵤₜ(k,n), Rₒᵤₜ(k,n), and Cₒᵤₜ(k,n) are respectively the left-channel frequency, right-channel frequency, and center-channel frequency signals. The upmix unit 37 upmixes the matrix-transformed left-channel frequency signal Lₒᵤₜ(k,n), the right-channel frequency signal Rₒᵤₜ(k,n), and the center-channel frequency signal Cₒᵤₜ(k,n), for example, to a 5.1-channel audio signal, based on the first spatial information SAC(k) received from the spatial information decoding unit 32 and residual signals res_{L}(k,n) and res_{R}(k,n) received from the residual signal decoding unit 36. Upmixing may be performed by using, for example, a method described in ISO/IEC23003.

The frequency-time transformation unit 38 transforms frequency signals received from the upmix unit 37 to time signals by using a QMF illustrated in the following equation.

$$IQMF ( k , n ) = \frac{1}{64} exp ( j \frac{π}{64} ( k + \frac{1}{2} ) ( 2 n - 127 ) ) , \\ 0 \leq k < 32 , \\ 0 \leq n < 32 \qquad ( Equation 21 )$$

In such a manner, the audio decoding device disclosed in Embodiment 3 is capable of accurately decoding an encoded audio signal with a reduced delay amount.

### Embodiment 4

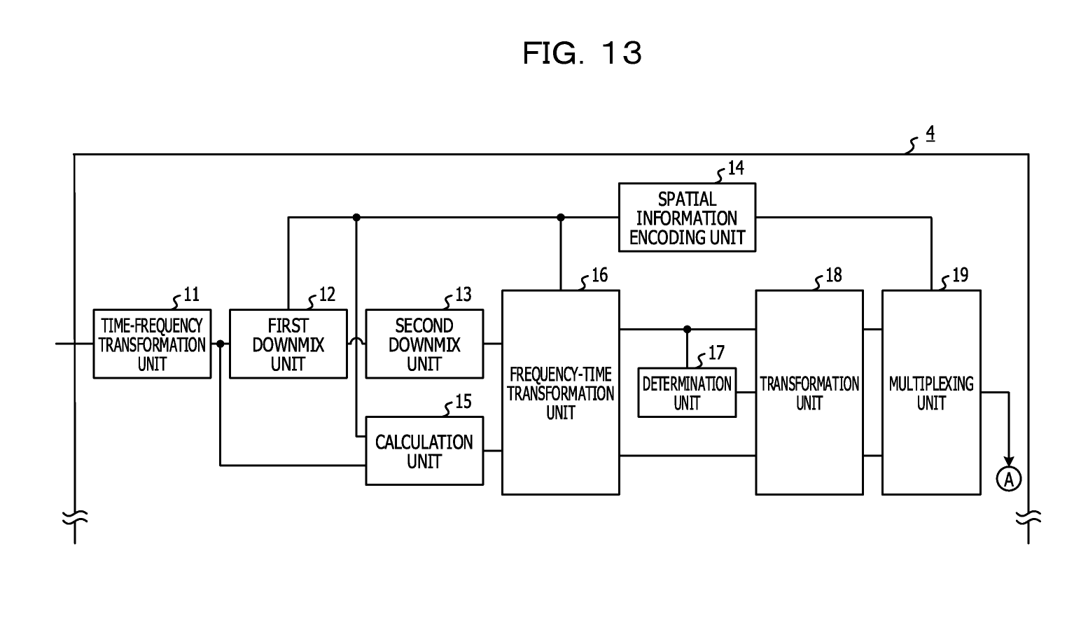

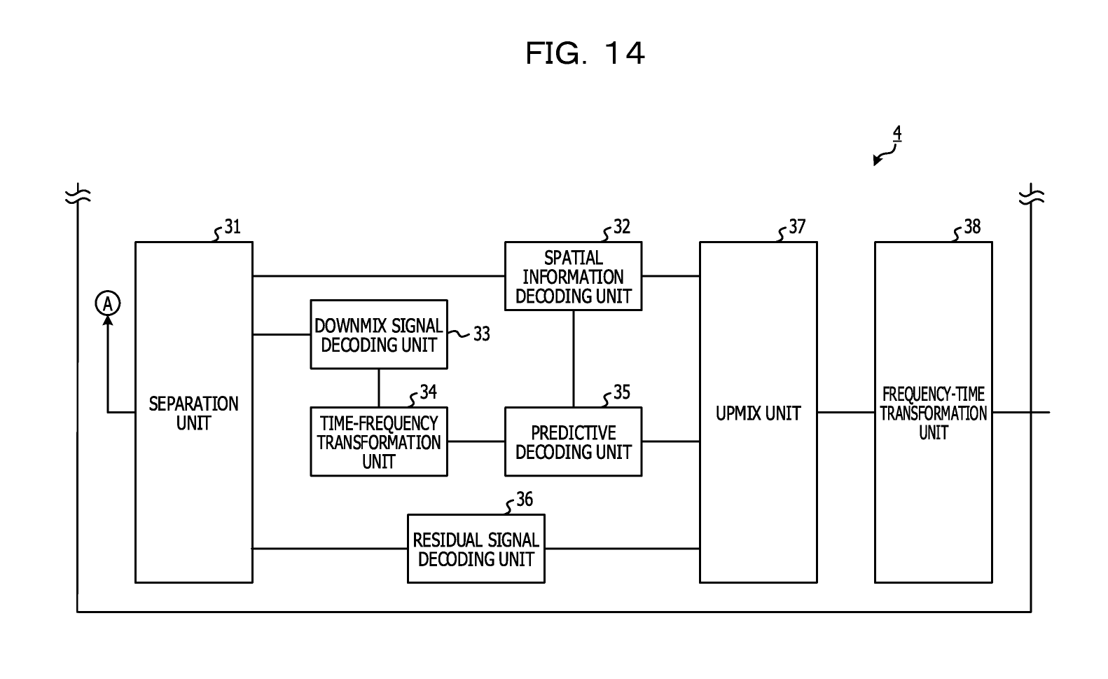

FIG. 13 is a functional block diagram (Part 1) of an audio encoding/decoding system 4 according to one embodiment. FIG. 14 is a functional block diagram (Part 2) of the audio encoding/decoding system 4 according to one embodiment. As illustrated in FIGS. 13 and 14, the audio encoding/decoding system 4 includes a time-frequency transformation unit 11, a first downmix unit 12, a second downmix unit 13, a spatial information encoding unit 14, a calculation unit 15, a frequency-time transformation unit 16, a determination unit 17, a transformer 18, and a multiplexing unit 19. The audio encoding/decoding system 4 includes a separation unit 31, a spatial information decoding unit 32, a downmix signal decoding unit 33, a time-frequency transformation unit 34, a predictive decoding unit 35, a residual signal decoding unit 36, an upmix unit 37, and a frequency-time transformation unit 38. Detailed description of functions of the audio encoding/decoding system 4 is omitted as being the same as those illustrated in FIGS. 1 and 2. The audio encoding/decoding system 4 disclosed in Embodiment 4 is capable of performing encoding and decoding with a reduced delay amount.

### Embodiment 5

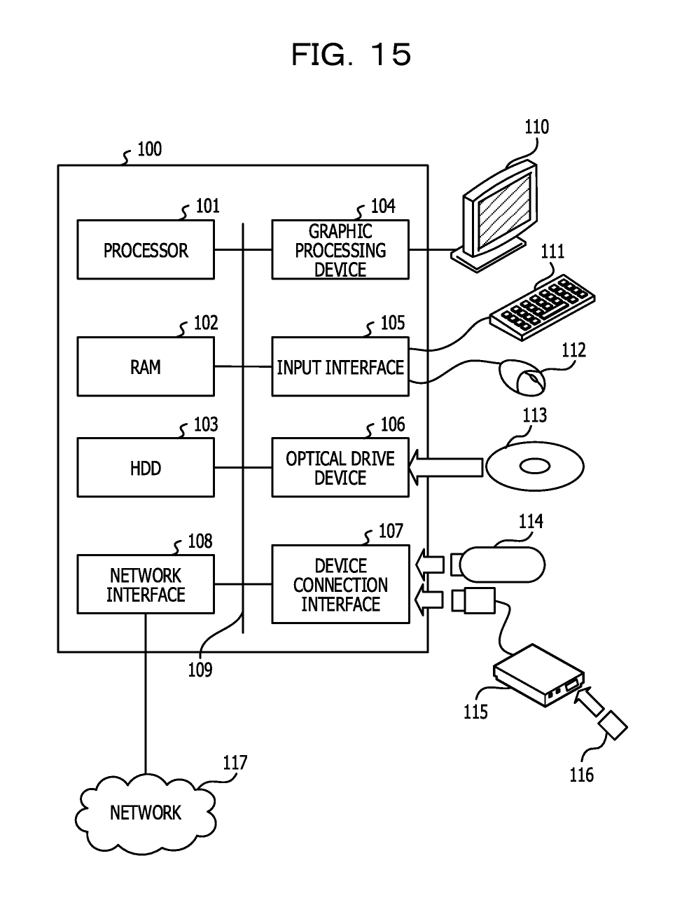

FIG. 15 is a hardware configuration diagram of a computer functioning as an audio encoding device 1 or an audio decoding device 3 according to one embodiment. As illustrated in FIG. 15, the audio encoding device 1 or the audio decoding device 3 includes a computer 100 and an input/output device (peripheral device) connected to the computer 100.

The computer 100 as a whole is controlled by a processor 101. The processor 101 is connected to a random access memory (RAM) 102 and multiple peripheral devices via a bus 109. The processor 101 may be a multiple processor. The processor 101 is, for example, CPU, micro processing unit (MPU), digital signal processor (DSP), application specific integrated circuit (ASIC), or programmable logic device (PLD). Further, the processor 101 may be a combination of two or more elements selected from CPU, MPU, DSP, ASIC and PLD.

For example, the processor 101 is capable of performing processing in functional blocks illustrated in FIG. 1, such as the time-frequency transformation unit 11, the first downmix unit 12, the second downmix unit 13, the spatial information encoding unit 14, the calculation unit 15, the frequency-time transformation unit 16, the determination unit 17, the transformer 18, the multiplexing unit 19, and so on. Further, the processor 101 is capable of performing processing in functional blocks illustrated in FIG. 12, such as the separation unit 31, the spatial information decoding unit 32, the downmix signal decoding unit 33, the time-frequency transformation unit 34, the predictive decoding unit 35, the residual signal decoding unit 36, the upmix unit 37, and the frequency-time transformation unit 38.

The RAM 102 is used as a main storage device of the computer 100. The RAM 102 temporarily stores at least a portion of programs of operating system (OS) for running the processor 101 and an application program. Further, the RAM 102 stores various data to be used for processing by the processor 101.

Peripheral devices connected to the bus 109 include a hard disk drive (HDD) 103, a graphic processing device 104, an input interface 105, an optical drive device 106, a device connection interface 107, and a network interface 108.

The HDD 103 magnetically writes and reads data from an incorporated disk. The HDD 103 is used, for example, as an auxiliary storage device of the computer 100. The HDD 103 stores an OS program, an application program, and various data. The auxiliary storage device may include a semiconductor storage device such as a flash memory.

The graphic processing device 104 is connected to a monitor 110. The graphic processing device 104 displays various images on a screen of the monitor 110 in accordance with an instruction given by the processor 101. The monitor 110 includes a display device and a liquid display device using a cathode ray tube (CRT).

The input interface 105 is connected to a keyboard 111 and a mouse 112. The input interface 105 transmits signals sent from the keyboard 111 and the mouse 112 to the processor 101. The mouse 112 is an example of pointing devices. Thus, another pointing device may be used. Other pointing devices include a touch panel, a tablet, a touch pad, a truck ball, and so on.

The optical drive device 106 reads data stored in an optical disk 113 by utilizing laser beam. The optical disk 113 is a portable recording medium in which data is recorded in such a manner allowing readout by light reflection. The optical disk 113 includes digital versatile disc (DVD), DVD-RAM, Compact Disc Read-Only Memory (CD-ROM), CD-Recordable (R)/ReWritable (RW), and so on. A program stored in the optical disk 113 serving as a portable recording medium is installed in the audio encoding device or the audio decoding device 3 via the optical drive device 106. A given program installed may be executed on the audio encoding device 1 or the audio decoding device 3.

The device connection interface 107 is a communication interface for connecting peripheral devices to the computer 100. For example, the device connection interface 107 may be connected to the memory device 114 and the memory reader writer 115. The memory device 114 is a recording medium having a function for communication with the device connection interface 107. The memory reader writer 115 is a device configured to write data into the memory card 116 or read data from the memory card 116. The memory card 116 is a card type recording medium.

A network interface 108 is connected to a network 117.

The network interface 108 transmits and receives data from other computers or communication devices via the network 117.

The computer 100 implements, for example, the above mentioned graphic processing function by executing a program recorded in a computer readable recording medium. A program describing details of processing to be executed by the computer 100 may be stored in various recording media. The above program may include one or more function modules. For example, the program may include function modules which implement processing illustrated in FIG. 1, such as the time-frequency transformation unit 11, the first downmix unit 12, the second downmix unit 13, the spatial information encoding unit 14, the calculation unit 15, the frequency-time transformation unit 16, the determination unit 17, the transformer 18, and the multiplexing unit 19. Further, the program may include function modules which implement processing illustrated in FIG. 12, such as the separation unit 31, the spatial information decoding unit 32, the downmix signal decoding unit 33, the time-frequency transformation unit 34, the predictive decoding unit 35, the residual signal decoding unit 36, the upmix unit 37, and the frequency-time transformation unit 38. A program to be executed by the computer 100 may be stored in the HDD 103. The processor 101 implements a program by loading at least a portion of the program stored in the HDD 103 into the RAM 102. A program to be executed by the computer 100 may be stored in a portable recording medium such as the optical disk 113, the memory device 114, and the memory card 116. A program stored in a portable recording medium becomes ready to run, for example, after being installed on the HDD 103 by control through the processor 101. Alternatively, the processor 101 may run the program by directly reading from a portable recording medium.

In the embodiments described above, components of illustrated respective devices may not be physically configured as illustrated. That is, specific separation and integration of devices are not limited to those illustrated, and devices may be configured by separating and/or integrating a whole or a portion thereof on an optional basis depending on various loads and utilization status.

Further, according to other embodiments, channel signal coding of the audio encoding device may be performed by coding the stereo frequency signal according to a different coding method. The multi-channel audio signal to be encoded or decoded is not limited to the 5.1-channel audio signal. For example, the audio signal to be encoded or decoded may be an audio signal having multiple channels such as 2 channels, 3 channels, 3.1 channels, or 7.1 channels. In this case, the audio encoding device also calculates frequency signals of the respective channels by performing time-frequency transformation of audio signals of the channels. Then, the audio encoding device downmixes frequency signals of the channels to generate a frequency signal with the number of channels less than an original audio signal.

Audio coding devices according to the above embodiments may be implemented on various devices used to convey or record an audio signal, such as a computer, video signal recorder or video transmission apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An audio encoding device comprising:
a processor; and
a memory which stores a plurality of instructions, which when executed by the processor, cause the processor to execute:
mixing a channel signal of a first number included in a plurality of channels contained in an audio signal as a downmix signal of a second number;
calculating a residual signal representing an error between the downmix signal and the channel signal of the first number;
determining a window length of the downmix signal; and
performing orthogonal transformation of the downmix signal and the residual signal based on the window length.

2. The device according to claim 1,
wherein, in the performing orthogonal transformation, the orthogonal transformation is performed by synchronizing a first delay amount based on the determination of the window length and a second delay amount based on the calculation of the residual signal to each other.

3. The device according to claim 1,
wherein the determining includes determining that the window length is short window length when the downmix signal includes an attack sound and that the window length is long window length when the downmix signal includes no attack sound.

4. An audio coding method comprising:
mixing a channel signal of a first number included in a plurality of channels contained in an audio signal as a downmix signal of a second number;
calculating, by a computer processor, a residual signal representing an error between the downmix signal and the channel signal of the first number;
determining a window length of the downmix signal; and
performing orthogonal transformation of the downmix signal and the residual signal based on the window length.

5. The method according to claim 4,
wherein, in the performing orthogonal transformation, the orthogonal transformation is performed by synchronizing a first delay amount based on the determination of the window length and a second delay amount based on the calculation of the residual signal to each other.

6. The method according to claim 4,
wherein the determining includes determining that the window length is short window length when the downmix signal includes an attack sound and that the window length is long window length when the downmix signal includes no attack sound.

7. A computer-readable non-transitory storage medium storing an audio coding program that causes a computer to execute a process comprising:
mixing a channel signal of a first number included in a plurality of channels contained in an audio signal as a downmix signal of a second number;
calculating a residual signal representing an error between the downmix signal and the channel signal of the first number;
determining a window length of the downmix signal; and
performing orthogonal transformation of the downmix signal and the residual signal based on the window length.

8. The medium according to claim 7,
wherein, in the performing orthogonal transformation, the orthogonal transformation is performed by synchronizing a first delay amount based on the determination of the window length and a second delay amount based on the calculation of the residual signal to each other.

9. The medium according to claim 7,
wherein the determining includes determining that the window length is short window length when the downmix signal includes an attack sound and that the window length is long window length when the downmix signal includes no attack sound.

10. An audio decoding device comprising:
a processor; and
a memory which stores a plurality of instructions, which when executed by the processor, cause the processor to execute:
separating an input signal in which a downmix signal code and a residual signal code are multiplexed,
the downmix signal code being generated by orthogonal transformation of a downmix signal of a second number to which a channel signal of a first number included in a plurality of channels contained in an audio signal is mixed, based on a window length of the downmix signal,
the residual signal code being generated by orthogonal transformation of a residual signal representing an error between the downmix signal and the channel signal of the first number, based on the window length and
upmixing the decoded downmix signal, based on the decoded residual signal.
